(19) United States
(12) Patent Application Publication
(10) Pub. No.: US 2026/0134399 A1
(43) Pub. Date: May 14, 2026

(54) JOB HISTORY INFORMATION COLLECTION APPARATUS AND METHOD OF COLLECTING JOB HISTORY INFORMATION

(71) Applicant: Murata Manufacturing Co., Ltd., Nagaokakyo-shi (JP)

(72) Inventors: Masaharu ITAYA, Nagaokakyo-shi (JP); Kazuki MATSUI, Nagaokakyo-shi (JP)

(73) Assignee: Murata Manufacturing Co., Ltd., Nagaokakyo-shi (JP)

(21) Appl. No.: 19/428,361

(22) Filed: Dec. 22, 2025

Related U.S. Application Data
(63) Continuation of application No. PCT/JP2024/016937, filed on May 7, 2024.

(30) Foreign Application Priority Data
Jun. 29, 2023 (JP) 2023-107107
Dec. 20, 2023 (JP) 2023-214925

(51) Int. Cl. G06Q 10/1053; G06F 40/242

(52) U.S. Cl. CPC G06Q 10/1053; G06F 40/242

(57) ABSTRACT

A job history information collection apparatus includes a memory configured to store computer code of a natural language processing algorithm, and circuitry configured to acquire format information including a necessary description item for a job history document, collect job history information related to a job history of a user by an interaction with the user and a natural language processing algorithm, determine whether the collected job history information satisfies a sufficiency requirement for the necessary description item using the natural language processing algorithm, and in response to a determination by the circuitry that the sufficiency requirement is satisfied, generate the job history document according to the format information.

### CROSS-REFERENCE TO RELATED APPLICATIONS

The present application is a continuation application of PCT Application No. PCT/JP 2024/016937, filed May 7, 2024, which claims priority to Japanese Patent Application No. 2023-107107, filed Jun. 29, 2023, and Japanese Patent Application No. 2023-214925, filed Dec. 20, 2023, the entire contents of each of which being incorporated by reference their entirety.

### TECHNICAL FIELD

The present disclosure relates to a job history information collection apparatus and a method of collecting job history information.

### BACKGROUND ART

A job history document plays a very important role as one of the criteria for a company employer to determine whether or not a job applicant meets the employment requirements. Thus, the job history document needs to be filled with information required of a job applicant without omission.

PTL 1 (Japanese Patent Laid-Open No. 2016-212533) discloses a document analysis apparatus that acquires determination reference data about the presence or absence of a necessary description item corresponding to the type of a document to be analyzed such as a personal resume, and, based on the data to be analyzed and the determination reference data, determines whether or not requested data related to the necessary description item exists in the document to be analyzed.

### Citation List

### Patent Literature

PTL 1: Japanese Patent Laid-Open No. 2016-212533

### SUMMARY

### Technical Problems

In the document analysis apparatus disclosed in PTL 1, even if there is redundant information related to the necessary description item, the existence of such redundant information cannot be checked.

The present disclosure has been made to solve the above-described, and other, problems, and an aspect thereof is to collect job history information without omission and redundancy of items related to necessary description items.

### Solutions to Problems

A job history information collection apparatus includes a memory configured to store computer code of a natural language processing algorithm, and circuitry configured to acquire format information including a necessary description item for a job history document, collect job history information related to a job history of a user by an interaction with the user and a natural language processing algorithm, determine whether the collected job history information satisfies a sufficiency requirement for the necessary description item using the natural language processing algorithm, and in response to a determination by the circuitry that the sufficiency requirement is satisfied, generate the job history document according to the format information.

A method of collecting job history information, the method including acquiring format information including a necessary description item for a job history document; collecting job history information related to a job history of a user by an interaction with the user using a natural language processing algorithm; determining whether the collected job history information satisfies a sufficiency requirement for the necessary description item using the natural language processing algorithm; and in response to determining that the sufficiency requirement is satisfied, generating the job history document according to the format information.

### Advantageous Effects of Disclosure

According to the present disclosure, job history information can be collected without omission and redundancy of the items related to the necessary description items.

### BRIEF DESCRIPTION OF DRAWINGS

FIG. 1 is a block diagram showing an outline of a matching system.

FIG. 2 is a block diagram showing configurations of a sharing server, a recruiter device, and an applicant device.

FIG. 3 is a block diagram showing a configuration of a generation server.

FIG. 4 is a diagram showing an example of a company database.

FIG. 5 is a diagram showing an example of a member database.

FIG. 6 is a diagram showing an example of a community database.

FIG. 7 is a diagram showing an example of a recruitment case database.

FIG. 8 is a diagram showing an example of a user database.

FIG. 9 is a diagram showing an example of an interaction conducted between the generation server and a user.

FIG. 10 is a diagram showing an example of the interaction conducted between the generation server and the user.

FIG. 11 is a diagram showing an example of the interaction (registration in dictionary) conducted between the generation server and the user.

FIG. 12 is a diagram showing an example of the interaction (registration in dictionary) conducted between the generation server and the user.

FIG. 13 is a diagram for illustrating a function of the generation server in terms of a divergence phase and a convergence phase.

FIG. 14 is a diagram showing a functional configuration of the generation server.

FIG. 15 is a flowchart showing a processing procedure of a data import unit.

FIG. 16 is a flowchart showing a processing procedure of an information acquisition unit.

FIG. 17 is a flowchart showing a processing procedure of a dictionary information registration unit.

FIG. 18 is a flowchart showing a processing procedure of a dictionary information display unit.

FIG. 19 is a flowchart showing a processing procedure of an information organization unit.

FIG. 20 is a flowchart showing a processing procedure of a job history document registration unit.

FIG. 21 is a timing chart showing a processing procedure of each of the sharing server, the recruiter device, the applicant device, and the generation server, each processing procedure being related to a job history document.

FIG. 22 is a diagram showing a functional configuration of a generation server according to a modification.

FIG. 23 is a diagram showing another example of the interaction conducted between the generation server and the user.

FIG. 24 is a diagram showing another example of the interaction conducted between the generation server and the user.

FIG. 25 is a diagram showing the functional configuration of the generation server including an IPC classification unit.

FIG. 26 is a flowchart showing a processing procedure of the IPC classification unit.

FIG. 27 is a diagram showing an example of a job history document including IPC (International Patent Classification).

FIG. 28 is a diagram showing an example of the job history document including IPC.

FIG. 29 is a diagram showing an example of the job history document including IPC.

FIG. 30 is a diagram showing an example of the job history document including IPC.

FIG. 31 is a diagram showing an example in which RAG technology is utilized for the functional configuration of the generation server.

### DESCRIPTION OF EMBODIMENTS

Hereinafter, embodiments of the present disclosure will be described in detail with reference to the drawings. In the drawings, the same or corresponding portions are denoted by the same reference characters, and the description thereof will not be repeated.

### Overall Configuration

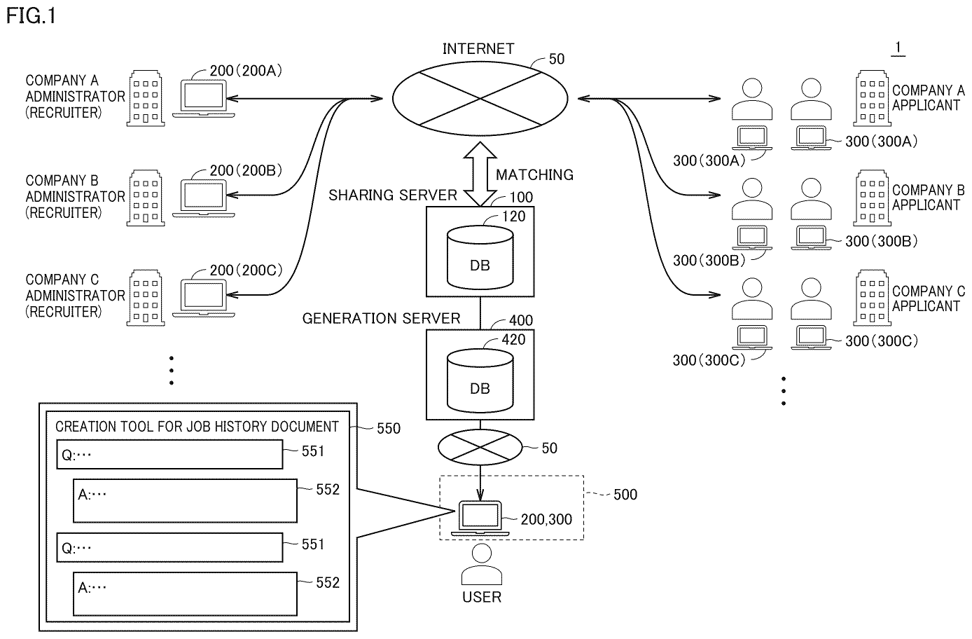

FIG. 1 is a block diagram showing an outline of a matching system 1. Matching system 1 is utilized, for example, for crowdsourcing between companies. Crowdsourcing is generally a process of recruiting contributions of an unspecified number of people to acquire required services, ideas, or contents.

In order to effectively utilize human resources, not a few companies are promoting side businesses for their employees. By utilizing crowdsourcing between companies, the capabilities of employees of the companies can be utilized.

Referring to FIG. 1, an outline configuration of matching system 1 will be hereinafter described. Matching system 1 includes a sharing server 100, recruiter devices 200A, 200B, 200C, . . . , applicant devices 300A, 300B, 300C, . . . , and a generation server 400.

Sharing server 100 provides a large number of companies with a matching service for providing matching between the order placement and the order acceptance of business between companies. FIG. 1 shows a company A, a company B, a company C, . . . as examples of companies utilizing such a matching service. Companies A, B, C, . . . are registered as company members of matching system 1. Among the employees of companies A, B, C, . . . , an employee who utilizes matching system 1 is also individually registered as a member of matching system 1.

The business offered in matching system 1 is, for example, temporary business assumed to be completed in a predetermined time period. Thus, a person who accepts an order of the business offered in matching system 1 is to engage in businesses including: a main business in a specific department to which he/she belongs in a company; and a side business offered in matching system 1. In matching system 1, for example, an applicant working at company A can also accept an order of the business from company A. Thus, in matching system 1, an order for the business in a department X of company A is permitted to be accepted by an applicant belonging to a different department Y of company A.

Hereinafter, the business for which recruitment of an order receiver is requested in matching system 1 may be referred to as “business under recruitment” or a “recruitment case”, a person who provides a recruitment case may be referred to as a “recruiter”, and a person who applies for an order of a recruitment case may be referred to as an “applicant”. Applying for the business under recruitment may be referred to as “application to business under recruitment” or “application to a recruitment case”.

The applicant who has received an order of the recruitment case corresponds to an “order receiver”, and the recruiter who has placed an order of the recruitment case to the order receiver corresponds to an “orderer”. Hereinafter, the “order receiver” may also be referred to as an “applicant” and the “orderer” may also be referred to as a “recruiter”.

A database 120 necessary for a matching service is constructed in sharing server 100. Database 120 includes various databases in each of which information necessary to provide the matching service is registered. For example, information about members, business under recruitment, and the like is registered in database 120. Sharing server 100 is managed and operated by a company different from companies using the matching service. Any of the companies using the matching service may manage and operate sharing server 100.

Recruiter device 200A is operated by an administrator of company A. Recruiter device 200B is operated by an administrator of company B. Recruiter device 200C is operated by an administrator of company C. Hereinafter, recruiter devices 200A, 200B, 200C, . . . may be collectively referred to as a “recruiter device 200”.

Applicant device 300A is operated by an applicant of company A. Applicant device 300B is operated by an applicant of company B. Applicant device 300C is operated by an applicant of company C. Hereinafter, applicant devices 300A, 300B, 300C, . . . may be collectively referred to as an “applicant device 300”. Although FIG. 1 shows two applicants for each company, the number of applicants is not limited thereto. A larger number of applicants may apply to each company, or one applicant may apply to a certain company. Sharing server 100 may accept, as an applicant, a person who does not belong to a company, such as a freelancer.

In the present embodiment, each of administrators of companies A, B, C, . . . plays a role as a recruiter. Thus, an administrator of each company may be hereinafter referred to as a “recruiter”. The recruiter can also behave as an applicant for the business for which another recruiter invites an applicant. In this case, recruiter device 200 functions as applicant device 300. In the present embodiment, when an administrator of a company behaves as a recruiter, a device used by the administrator to use the matching service is referred to as recruiter device 200.

The number of administrators in company A may be one or may be more than one. When an administrator is placed in company A, recruiter device 200 may be provided to each administrator, or one recruiter device 200 may be shared by a plurality of administrators. The same also applies to companies B, C, . . . .

Sharing server 100 and recruiter device 200 are configured to be able to communicate with each other via the Internet 50, which is an example of a communication network. Sharing server 100 and applicant device 300 are configured to be able to communicate with each other via the Internet 50.

When receiving access from recruiter device 200, sharing server 100 requests sign-in that involves inputting of a member ID and a password. Similarly, when receiving access from applicant device 300, sharing server 100 requests sign-in that involves inputting of a member ID and a password. Sharing server 100 specifies each of recruiters and each of applicants by a corresponding member ID notified at the time of sign-in.

Recruiter device 200 receives various operations by the recruiter. For example, recruiter device 200 receives an operation of inputting a recruitment case (requested business), an operation of inputting an evaluation of an order receiver who has completed the business, an operation of searching for a member of the matching service, and the like.

In response to each operation on recruiter device 200, recruiter device 200 communicates with sharing server 100. In response to the operation of inputting a recruitment case (requested business), sharing server 100 registers the recruitment case into database 120; in response to the operation of inputting an evaluation, sharing server 100 registers the evaluation of the target applicant (order receiver) into database 120; and, in response to the operation of searching for a member, sharing server 100 provides the information about the member to recruiter device 200.

Applicant device 300 receives various operations by the applicant. For example, applicant device 300 receives an operation of searching for a recruitment case, an operation of applying for a recruitment case, an operation of inputting business performance, an operation of inputting an evaluation of a recruiter (an orderer), and the like.

In response to each operation on applicant device 300, applicant device 300 communicates with sharing server 100. In response to the operation of searching for a recruitment case, sharing server 100 provides an appropriate recruitment case to applicant device 300; in response to the operation of applying for a recruitment case, sharing server 100 issues a notification about adoption or rejection to applicant device 300; in response to the operation of inputting business performance, sharing server 100 registers the business performance into database 120; and, in response to the operation of inputting an evaluation, sharing server 100 registers the evaluation of a target recruiter (orderer) into database 120.

By using matching system 1, a recruiter belonging to a certain department of company A can adopt an applicant belonging to another department of company A as an order receiver of the recruitment case. By using matching system 1, a recruiter belonging to company A can adopt an applicant belonging to company B as an order receiver of the recruitment case.

A member who uses matching system 1 accesses sharing server 100 as a recruiter or an applicant. Hereinafter, the member of matching system 1 may be referred to as a “user”. Hereinafter, recruiter device 200 and applicant device 300 operated by members may be collectively referred to as a “user device 500”.

Sharing server 100 is communicably connected to generation server 400. Generation server 400 provides a user with an interface for assisting creation of a job history document. In generation server 400, a database 420 necessary for providing such an interface to the user is constructed. Generation server 400 may be managed by a company that manages sharing server 100, or may be managed by a company different from the company that manages sharing server 100. Sharing server 100 may include the function of generation server 400.

Generation server 400 is communicably connected to user device 500 via the Internet 50. User device 500 includes recruiter device 200 and applicant device 300. The user accesses generation server 400 through use of user device 500.

Similarly to sharing server 100, when receiving access from user device 500, generation server 400 requests sign-in that involves inputting of a member ID and a password. Generation server 400 specifies a user by the member ID notified at the time of sign-in.

Generation server 400 provides the user with an interface for assisting creation of a job history document. Thereby, a creation tool for a job history document is displayed on a screen 550 of user device 500. Generation server 400 is an example of the job history information collection apparatus.

Generation server 400 has a function of collecting job history information necessary for creating a job history document from a user without omission while interacting with the user by causing screen 550 to display a question frame 551 and an answer frame 552. Generation server 400 creates a job history document in a uniform format based on the collected job history information. Generation server 400 causes screen 550 to display the created job history document and provides the user with an opportunity to check the job history document. Generation server 400 stores, in generation server 400, the job history document checked by the user. When the user applies for a recruitment case, generation server 400 transmits his/her job history document to recruiter device 200 in cooperation with sharing server 100.

The reason why generation server 400 is introduced into matching system 1 is due to “complication in creating a job history document” and “difficulty in uniformizing a job history document”, each of which will be hereinafter described in detail.

### Complication in Creating Job History Document

In order to efficiently utilize personnel in a company, it is effective to clarify the employee's individual skills and job experiences. In order to clarify the employee's individual skills and job experiences, it is necessary to collect as many pieces of individual information as possible without omission and to organize the collected pieces of information in a uniform document format.

However, it is a very cumbersome action for a job applicant to remind himself/herself about his/her skills and job experiences and then organize them into a uniform document format.

It is natural that a person who wishes to formally change his/her job will be able to keep constant motivation to address the above-mentioned cumbersome action in order to prepare for rigorous document examinations, interviews, and the like. On the other hand, keeping motivation to address the above-mentioned cumbersome action is difficult for an employee who applies for an in-house project or an employee who wishes to do a side business outside the company, because such an employee does not intend to formally change his/her job and is not required to undergo highly challenging document examinations and multifaceted interviews.

Thus, in the case of what is called an “in-house” situation, it can be said that the applicant has a low motivation to address the above-mentioned cumbersome action. In such a case, there is a problem that a job applicant cannot collect information about his/her individual skills and job experiences without omission and organize the collected pieces of information into a uniform document format.

Creating a high-quality job history document requires many pieces of information about individual's skills and job histories. However, in the case of an in-house situation, even if there are many pieces of information at hand, a relatively large number of job applicants are not motivated to write their job history documents and feel it troublesome (cumbersome) to write their skills, job histories, and the like. In this case, the amount of information included in the job history document tends to be small. Thus, there is a problem that, even if a job applicant has many pieces of information at hand, he/she cannot organize such pieces of information into a uniform document format.

### Difficulty in Uniformizing Job History Document

If the job history documents can be prepared with the same precision, it is easy for an evaluator to evaluate each of the applicants' job histories. Further, if the job history documents can be prepared with the same precision, a company can group the job history documents of its employees to thereby enable effective talent management. However, since job history documents are generally written in a free format, the styles of the job history documents are different depending on creators. Even if creators are requested to write the job history documents in a uniform format, it is difficult for the creators to prepare the job history documents with the same precision because they have different document creation capabilities. Due to creator's carelessness, redundant descriptions may be mixed into the job history document. Thus, it takes time for the evaluator to evaluate the job history of each applicant based on the applicant's job history document. Also, companies have difficulty in grouping applicants' job histories based on the job history documents.

Due to the background as described above, generation server 400 is introduced into matching system 1. According to generation server 400, pieces of job history information are collected without omission from the user in an interactive form, and a job history document is created in a uniform format. In the created job history document, a job history related to necessary description items is described without omission and redundancy.

According to the present embodiment, the user can be assisted such that the user can create a job history document in which items related to necessary description items are described without omission and without redundant description. In addition, according to the present embodiment, the user can be assisted such that the user can create a job history document appropriately reflecting the user's job history irrespective of the user's document creation capability. According to the present embodiment, job history information can be collected without omission and redundancy of the items related to necessary description items.

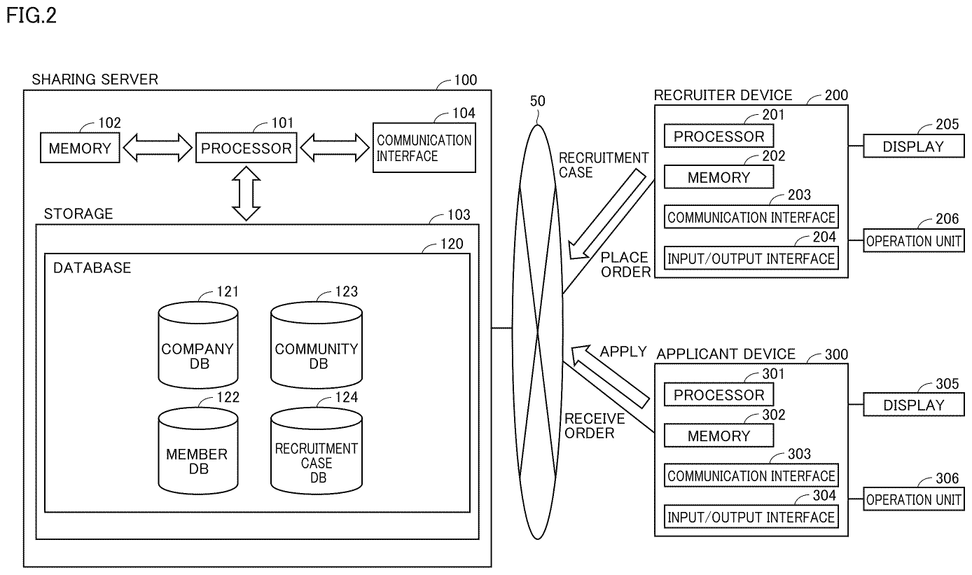

FIG. 2 is a block diagram showing configurations of sharing server 100, recruiter device 200, and applicant device 300.

### Configuration of Sharing Server 100

Sharing server 100 includes circuitry such as a processor 101 (e.g., one or more programmable CPUs or GPUs that are local devices or networked via a network, or cloud resources), a memory 102, a storage 103, and a communication interface 104.

Memory 102 includes a random access memory (RAM), a read only memory (ROM), a flash memory, or any other suitable memory system. Memory 102 stores a program necessary for arithmetic processing of processor 101, temporary data calculated in the arithmetic processing, and the like.

Storage 103 is constituted of a hard disk drive, a solid state drive, and the like. Storage 103 stores database 120. Database 120 includes a plurality of types of databases. The plurality of types of databases include a company database (company DB) 121, a member database (member DB) 122, a community database (community DB) 123, and a recruitment case database (recruitment case DB) 124.

Some of the plurality of types of databases may be stored in a storage provided separately from sharing server 100. For example, connection may be made to a cloud service different from sharing server 100, and some of the plurality of types of databases shown in FIG. 2 may be stored in the cloud. In this case, sharing server 100 can access a necessary database through communication with the cloud via the Internet 50.

Processor 101 connects to the Internet 50 via communication interface 104 in accordance with a program stored in memory 102. Processor 101 connects to the Internet 50 and communicates with recruiter device 200 and applicant device 300. Processor 101 accesses database 120 and executes: a process of extracting necessary data; a process of registering new data into database 120; a process of updating the data registered in database 120; and the like.

### Configuration of Recruiter Device 200

Recruiter device 200 includes a processor 201, a memory 202, a communication interface 203, an input/output interface 204, a display 205, and an operation unit 206. Operation unit 206 is constituted of a mouse, a keyboard, and the like.

Memory 202 includes a random access memory (RAM), a read only memory (ROM), a flash memory, or any other suitable memory system. Memory 202 stores a program necessary for arithmetic processing of processor 201, temporary data calculated in the arithmetic processing, and the like.

Processor 201 connects to the Internet 50 via communication interface 203 in accordance with a program stored in memory 202. Processor 201 connects to the Internet 50 and communicates with sharing server 100. Processor 201 communicates with sharing server 100, and executes: a process of transmitting a recruitment case; a process of causing display 205 to display information of a member who is an applicant; a process of placing an order of business to an order receiver selected from among applicants; a process of transmitting, to sharing server 100, a content of an evaluation of the order receiver that has been input by a recruiter; and the like.

Processor 201 is notified, through input/output interface 204, about the information input by the operation of operation unit 206.

### Configuration of Applicant Device 300

Applicant device 300 includes a processor 301, a memory 302, a communication interface 303, an input/output interface 304, a display 305, and an operation unit 306. Operation unit 306 is constituted of a mouse, a keyboard, and the like.

Memory 302 includes a random access memory (RAM), a read only memory (ROM), a flash memory, or any other suitable memory system. Memory 302 stores a program necessary for arithmetic processing of processor 301 (e.g., execution of computer code stored in the memory 302 by the processor 301 configures the processor to perform the specification operations), temporary data calculated in the arithmetic processing, and the like.

Processor 301 connects to the Internet 50 via communication interface 303 in accordance with a program stored in memory 302. Processor 301 connects to the Internet 50 and communicates with sharing server 100. Processor 301 communicates with sharing server 100, and executes: a process of applying for a recruitment case; a process of causing display 305 to display a notification about adoption or rejection for the applied case; a process of transmitting, to sharing server 100, the actual result of the business of the received order; a process of transmitting, to sharing server 100, a content of an evaluation of the recruiter that has been input by an applicant; and the like.

Processor 301 is notified, through input/output interface 304, about the information input by the operation of operation unit 306.

### Database 120

Hereinafter, database 120 will be described. In company database 121, information about each of companies participating in matching system 1 is registered. In member database 122, information about each of members using matching system 1 is registered. Many of the members are employees of the companies participating in matching system 1.

Each of the members registered in member database 122 can act as a recruiter (an orderer) or an applicant (an order receiver) by using matching system 1. The members may include not only employees belonging to the companies registered in company database 121, but also individuals (freelancers) not belonging to any of the companies.

Community database 123 stores pieces of information for specifying companies belonging to communities. Each of the communities is formed by an agreement between companies. Therefore, a plurality of communities can be formed depending on a manner of agreement made between companies. The number of companies belonging to one community can also be variously set. Between companies establishing a community relationship, a relationship of trust is formed within a range determined by a manner of agreement when forming a community. In community database 123, information for specifying a company belonging to a community is registered on the community basis.

In recruitment case database 124, businesses each for which recruitment of an order receiver is requested (recruitment cases) are registered. While engaging in the business of his/her department in a company, an employee of each company can receive, as a member of matching system 1, an order of a case submitted from another department of his/her company or an order of a case submitted from another company, each of these cases being registered in recruitment case database 124. In this case, the member receives the order of the case from another department of his/her company or the order of the case from another company as a side business.

### Configuration of Generation Server 400

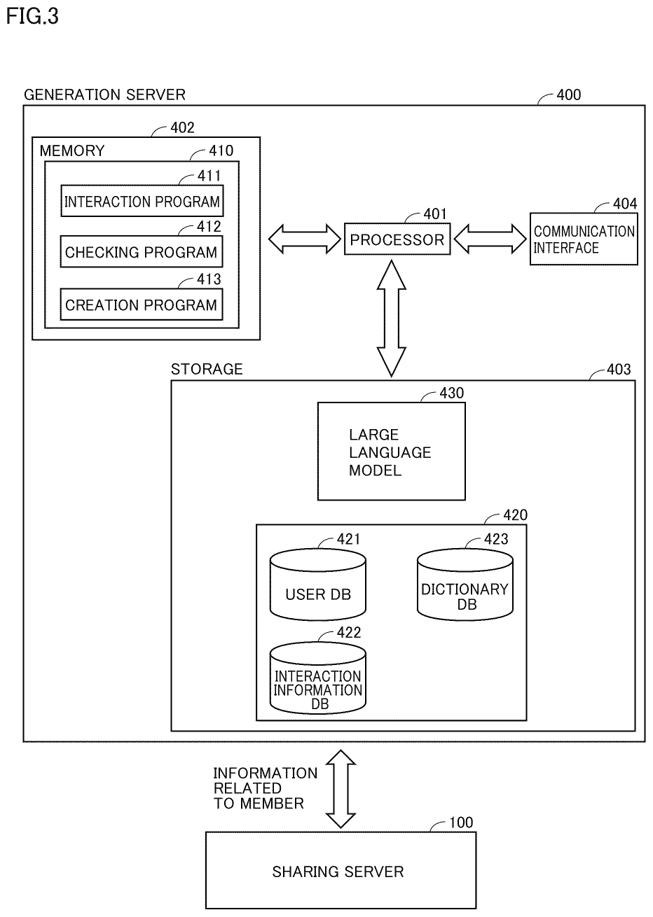

FIG. 3 is a block diagram showing a configuration of generation server 400. Generation server 400 includes a processor 401, a memory 402, a storage 403, and a communication interface 404.

Memory 402 includes a random access memory (RAM), a read only memory (ROM), a flash memory, or any other suitable memory system. Memory 402 stores a program necessary for arithmetic processing of processor 401, temporary data calculated in the arithmetic processing, and the like.

Storage 403 is constituted of a hard disk drive, a solid state drive, and the like. Storage 403 stores a database 420 and a large language model (LLM) 430. Large language model 430 is an example of a natural language processing algorithm. Storage 403 is an example of a storage unit in which a natural language processing algorithm is stored.

Large language model 430 is a language model (a trained language model) trained in advance by machine learning. A huge amount of text data is used to train large language model 430. Large language model 430 is formed as an autoregressive model, for example, using a transformer such as a Generative Pre-trained Transformer (GPT). Large language model 430 according to the present embodiment may include Bard and the like in addition to GPT (GPT-2, GPT-3, and GPT-4).

Database 420 includes a plurality of types of databases. The plurality of types of databases include a user database (user DB) 421, an interaction information database (interaction information DB) 422, and a dictionary database (dictionary DB) 423.

Memory 402 stores a program (an algorithm) 410. Processor 401 executes a program (algorithm) 410 to create a job history document through use of large language model 430.

Program 410 includes an interaction program 411, a checking program 412, and a creation program 413. Processor 401 executes interaction program 411 to interact with the user through use of large language model 430. Thereby, processor 401 acquires a large number of pieces of job history information from the user. By executing checking program 412, processor 401 checks, through use of large language model 430, that the job history information necessary for creating a job history document has been acquired without omission. By executing creation program 413, processor 401 creates a job history document in accordance with a pre-defined format through use of large language model 430.

### Database 420

Hereinafter, database 420 will be described. In user database 421, “job history information” and a “job history document” are registered by the user's member ID. In the present disclosure, the “job history information” means information used to create a “job history document”. For example, before interacting with the user, generation server 400 can receive job history information in a file format from the user through user device 500. Upon receipt of the job history information from the user, generation server 400 registers the job history information into user database 421 by the user's member ID.

If the job history information registered in user database 421 includes all pieces of information necessary for creating a job history document, generation server 400 creates a job history document without interacting with the user.

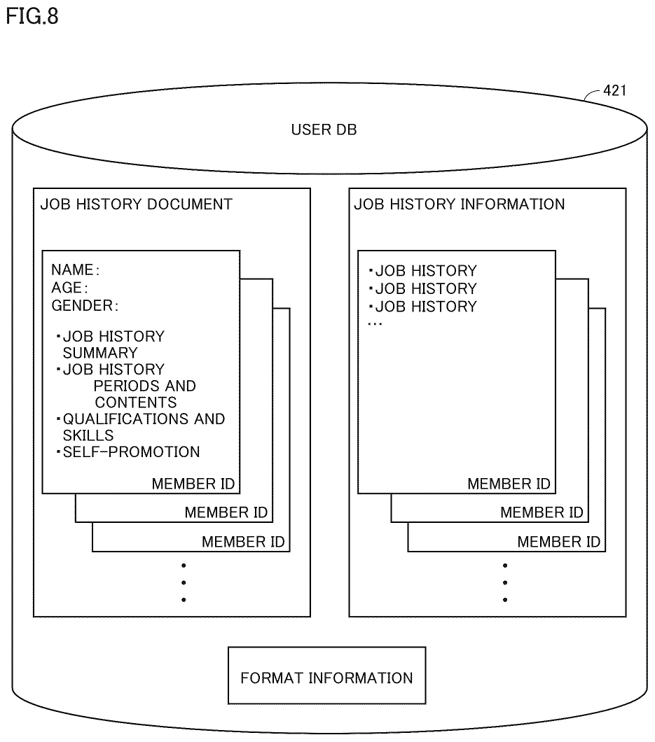

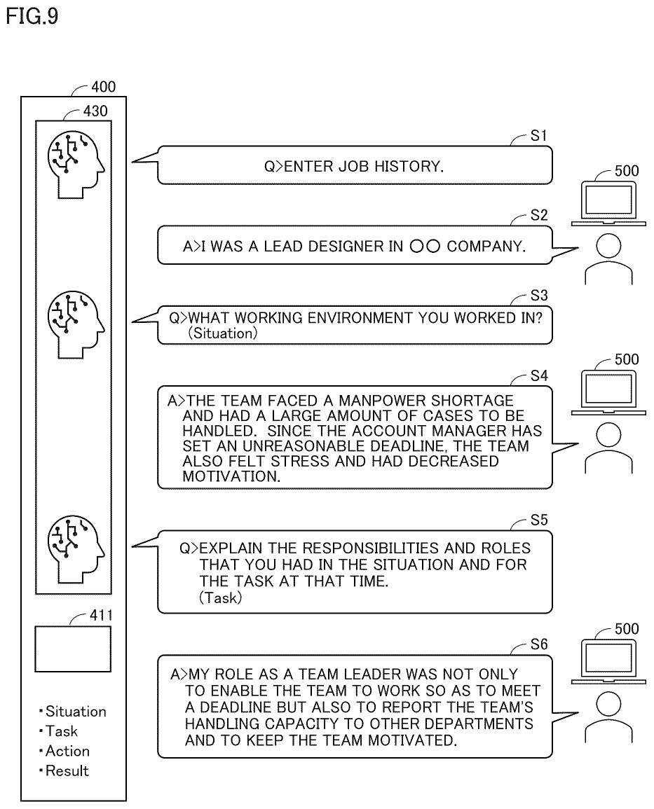

Generation server 400 interacts with the user in order to acquire job history information from the user. In interaction information database 422, the “job history information” acquired through the interaction is registered by the member ID. Generation server 400 generates a “job history document” using the “job history information” registered in interaction information database 422. If the “job history information” is registered in user database 421, generation server 400 generates a “job history document” using the “job history information” registered in user database 421 and the “job history information” registered in interaction information database 422. Generation server 400 registers the generated “job history document” into user database 421. The configuration of user database 421 will be described later in detail with reference to FIG. 8.

In dictionary database 423, terms extracted in the interaction between generation server 400 and the user and the meanings of these terms are registered. Generation server 400 associates, with dictionary database 423, a term included in the description of the job history document and registered in the dictionary. Generation server 400 (or sharing server 100) causes user device 500 to display the job history document. Generation server 400 (or sharing server 100) causes user device 500 to display the meaning of the term when the user clicks, with a mouse, on the term included in the description of the job history document and registered in the dictionary.

Large language model 430 or some of the plurality of types of databases may be stored in a storage provided separately from generation server 400. For example, connection may be made to a cloud service different from generation server 400, and some of the plurality of types of databases or large language model 430 shown in FIG. 3 may be stored in the cloud. In this case, generation server 400 can access a necessary database or large language model 430 through communication with the cloud via the Internet 50.

Processor 401 connects to the Internet 50 via communication interface 404 in accordance with a program stored in memory 402. Processor 401 connects to the Internet 50 and communicates with user device 500 (see FIG. 1). Processor 401 accesses database 420 and executes a process of extracting necessary data, a process of registering new data into database 420, a process of updating the data registered in database 420, and the like.

Processor 401 communicates with sharing server 100. For example, in response to a request from sharing server 100, processor 401 transmits a job history document of a member (a user) registered in user database 421 to sharing server 100.

### Company Database 121

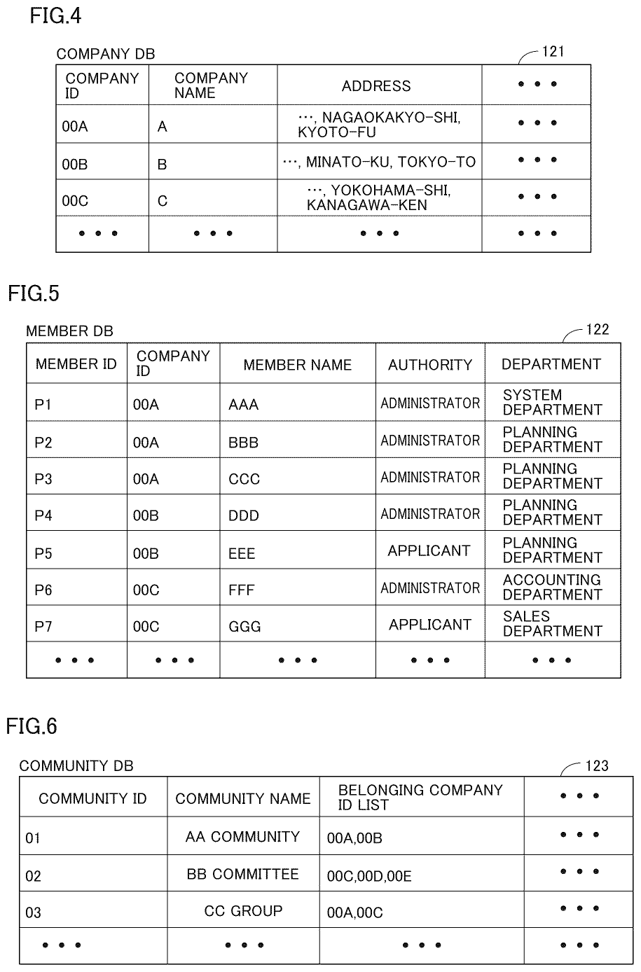

FIG. 4 is a diagram showing an example of company database 121. In company database 121, a company ID for identifying a company, a company name, a company address, and the like are registered for each company. In the present embodiment, members are permitted to apply for businesses each for which recruitment is requested from various companies and departments and also permitted to receive orders of the businesses.

### Member Database 122

FIG. 5 is a diagram showing an example of member database 122. Various types of information about members are registered in member database 122. The various types of information about members include a member ID for identifying a member, an ID of a company to which the member belongs, a member name, authority of the member, and a department to which the member belongs.

The types of member's authority include an administrator and an applicant. A member who has administrator authority is authorized to use matching system 1 as a recruiter and an applicant. A member who has applicant authority is authorized to use matching system 1 as an applicant, but is not authorized to use matching system 1 as a recruiter. A department head in a company is given administrator authority in order to manage the conditions of the side business of his/her subordinate in the department. An administrator who has administrator authority is authorized to approve of his/her subordinate making an application as an applicant. Thus, the administrator functions as an approver.

### Community Database 123

FIG. 6 is a diagram showing an example of community database 123. In community database 123, information about a community formed between companies is registered. The information about a community includes a community ID for identifying a community, a community name, and an ID list of companies belonging to the community. Each company can form various communities by agreeing with other companies. A company belonging to a community can change a target company belonging to its community by agreement with other companies.

### Recruitment Case Database 124

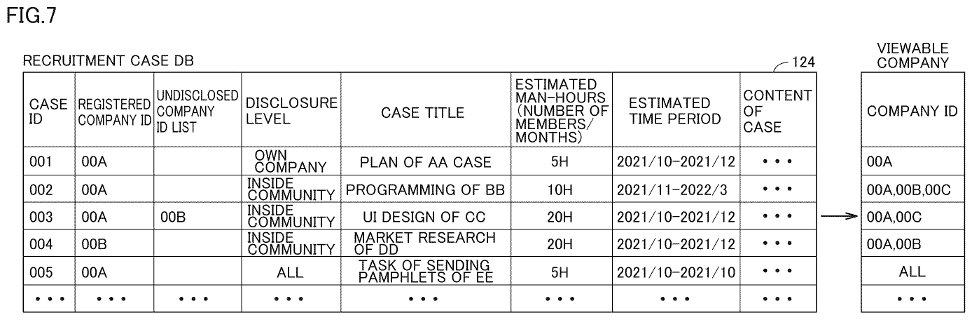

FIG. 7 is a diagram showing an example of recruitment case database 124. In recruitment case database 124, information about a recruitment case is registered. The information about the recruitment case includes a case ID for identifying a recruitment case, an ID of a company to which a recruiter who has registered the recruitment case belongs, an undisclosed company ID list, a disclosure level, a case title, estimated man-hours, an estimated time period, and a content of a case.

In the undisclosed company ID list, an ID of a company that prohibits disclosure of a recruitment case is registered. As the disclosure level, any one of three levels of “own company”, “inside community”, and “all” is set. When the disclosure level is set to “all”, the disclosure target also includes an applicant outside the community.

On the right side of recruitment case database 124, FIG. 7 shows IDs of companies whose recruitment cases can be viewed. For example, for the recruitment case corresponding to a case ID=001, the disclosure level is set to “own company”. In this case, only the members belonging to the company (company ID=00A) that has registered a recruitment case can view the recruitment case corresponding to the case ID=001.

Hereinafter, through use of case IDs, recruitment cases corresponding to respective case IDs may be referred to as a case 001, a case 002, a case 003, . . . . Similarly, through use of community IDs, communities corresponding to respective community IDs may be referred to as a community 01, a community 02, a community 03, . . . . Also, through use of member IDs, members corresponding to respective member IDs may be referred to as a member P1, a member P2, a member P3, . . . . Further, through use of some of company IDs, companies corresponding to respective company IDs may be referred to as a company A, a company B, a company C, . . . .

In case 002, the disclosure level is set to “inside community”. According to community database 123 shown in FIG. 6, companies having a community relationship with company A that has registered case 002 are companies B and C. Thus, as shown in FIG. 7, only members belonging to any of companies A, B, and C can view case 002.

Case 003 shows the same registered company and the same disclosure level for the recruitment case as those of case 002. However, in case 003, “00B” is registered in the undisclosed company ID list. Thus, as shown in FIG. 7, only members belonging to any of companies A and C can view case 003, and members belonging to company B are not authorized to view case 003.

In the recruitment case in which the disclosure level is set to “all”, all the members can view a target recruitment case. A case 005 shown in FIG. 7 corresponds to this. If one company ID or a plurality of company IDs is or are registered in the undisclosed company ID list of case 005, a member belonging to any of the companies having the company ID(s) is not authorized to view case 005.

The estimated man-hours and the estimated time period are used by an applicant and matching system 1 to estimate the time period required for addressing a recruitment case.

Each of company database 121, member database 122, and community database 123 may be shared by sharing server 100 and generation server 400. The recruiter's member ID corresponding to the recruitment case may be registered in recruitment case database 124.

### User Database

FIG. 8 is a diagram showing an example of user database 421. As shown in FIG. 8, in user database 421, “job history information” and a “job history document” of each of members (users) are registered by the member ID. As described above, the “job history information” means the information used to create a “job history document”. The “job history document” is created based on the “job history information”. In the present embodiment, there are a situation in which the “job history information” is acquired in advance before an interaction between generation server 400 and the user, and a situation in which the “job history information” is acquired by an interaction between generation server 400 and the user.

The format of the job history document is defined in advance by a designer. The format of the job history document includes the type of necessary description items and the order in which the necessary description items are described.

The necessary description items for the job history document include “formal items” and “substantial items”. The formal items include, for example, “name”, “age”, “gender”, “job history summary”, “job history (periods and contents)”, “qualifications and skills”, “self-promotion (PR)”, and the like. As shown in FIG. 8, these formal items are arranged in the job history document in the order of “name”, “age”, “gender”, “job history summary”, “job history (periods and contents)”, “qualifications and skills”, and “self-promotion (PR)”. In the job history document created by generation server 400, the “formal items” shown in FIG. 8 are described in the order shown in FIG. 8. The types and the order of description of the “formal items” shown in FIG. 8 are merely examples.

The job history document includes contents corresponding to the respective “formal items”. The contents to be described in the job history document include “substantial items” determined in advance. In the present embodiment, an item called “STAR” is introduced as an example of the “substantial item”.

In general, “STAR” is known as one of the methods used by an interviewer to effectively conduct an interview with a job applicant. “STAR” is a coined term created by combining initial letters of “situation (S)”, “task (T)”, “action (A)”, and “result (R)”. Generation server 400 acquires job history information from the user so as to include the user's job history items related to these four items intended by “STAR”, and creates a job history document through use of the acquired job history information.

In user database 421, format information of a job history document is registered separately from the job history document (including contents) created for each user. This format information includes necessary description items (formal items and substantial items) for a job history document. Generation server 400 executes a process related to support for creating a job history document while referring to a format registered in user database 421.

The job history information registered in user database 421 is information based on which a job history document is created, similarly to the job history information obtained by an interaction between generation server 400 and the user. If the job history information is not registered in user database 421, generation server 400 creates a job history document based on the “job history information” obtained by an interaction with the user. Thus, in the present disclosure, it is not essential that job history information is registered in user database 421. User database 421 is an example of a job history database in which the job history information collected before an interaction by the collection unit is registered.

The “job history information” is, for example, information about the name and the department of the company for which the user has worked in the past, and the user's job contents, job experience, and length of service, and includes information related to the above-mentioned “STAR”. Alternatively, the “job history information” is information about qualifications possessed by the user.

The “job history information” includes fragmentary information about the user's job history. The fragmentary information is, for example, information about one of a plurality of necessary description items included in a job history document. One of the plurality of necessary description items is, for example, information about qualifications possessed by the user. Alternatively, the fragmentary information is information constituting a part of the necessary description items. For example, if a user has three qualifications, fragmentary information is information about one of the three qualifications.

User database 421 constitutes database 420 together with interaction information database 422 and dictionary database 423. In this case, user database 421 of database 420 has been described in detail with reference to the drawing. Since interaction information database 422 and dictionary database 423 have already been described for understanding the respective configurations, the description of interaction information database 422 and dictionary database 423 will not be hereinafter repeated.

### Example of Interaction

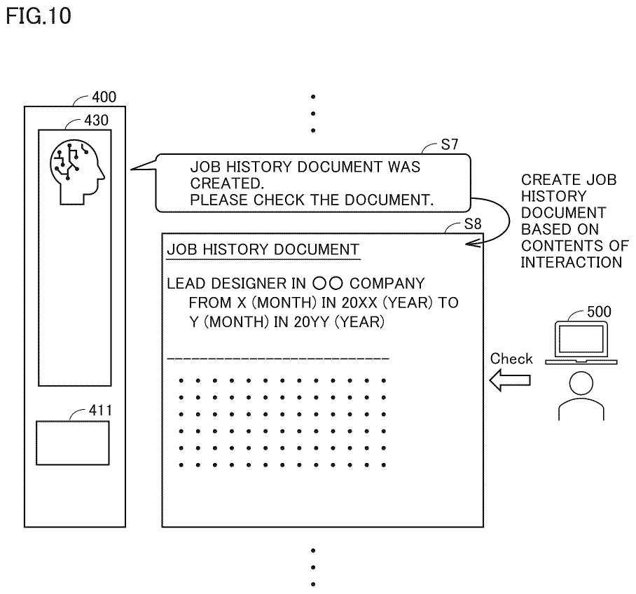

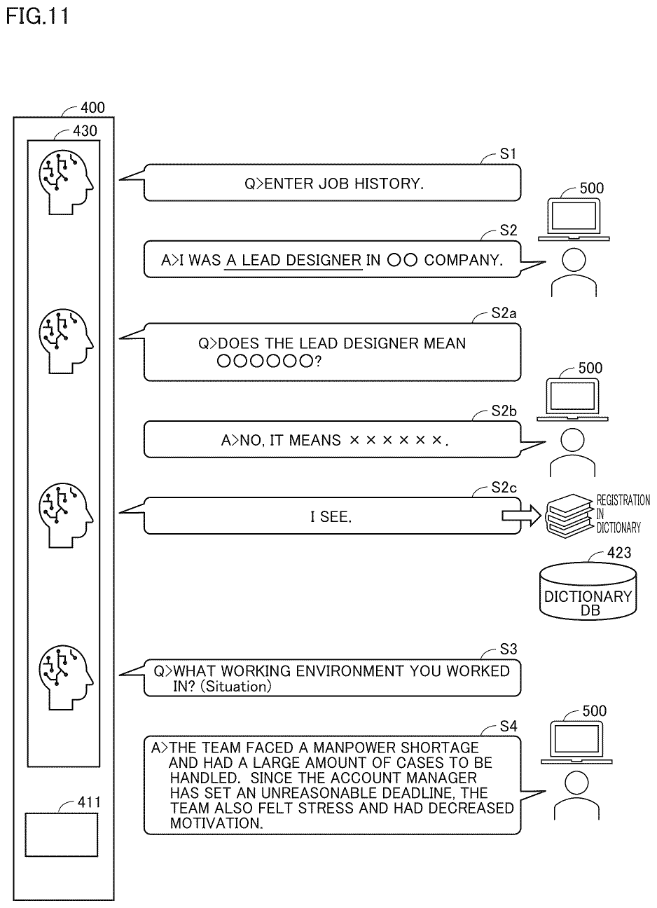

FIGS. 9 and 10 are diagrams each showing an example of an interaction conducted between generation server 400 and a user. The user accesses generation server 400 through use of user device 500. Through use of large language model 430, generation server 400 interacts with the user in a procedure as exemplified below. In particular, generation server 400 diverges the interaction with the user such that all of the user's job histories are acquired without omission in terms of STAR (Situation, Task, Action, Result) related to the necessary description items. Thereby, generation server 400 acquires, without omission, the user's job history information necessary for creating a job history document.

The following describes an example in which generation server 400 interacts with the user through a screen of user device 500. In other words, generation server 400 causes the screen of user device 500 to display a request sentence and a question sentence to thereby inquire of the user about the job history. The user responds to the inquiry by inputting a sentence using a keyboard or the like of user device 500. Generation server 400 may interact with the user by voice.

First, generation server 400 causes the screen to display a request sentence, “enter job history.” (step S1). In response to the request in step S1, the user answers, “I was a lead designer in ○○ Company.” (step S2).

Based on the answer in step S2, generation server 400 causes the screen to display an inquiry sentence, “what working environment you worked in?” (step S3). In response to the inquiry in step S3, the user answers, “the team faced a manpower shortage and had a large amount of cases to be handled. Since the account manager has set an unreasonable deadline, the team also felt stress and had decreased motivation.” (step S4).

Based on the answer in step S4, generation server 400 causes the screen to display an inquiry sentence, “explain the responsibilities and roles that you had in the situation and for the task at that time.” (step S5). In response to the inquiry in step S5, the user answers, “my role as a team leader was not only to enable the team to work so as to meet a deadline but also to report the team's handling capacity to other departments and to keep the team motivated.” (step S6).

Hereinafter, in a similar manner, generation server 400 interacts with the user in a chat format to acquire job history information necessary for creating a job history document from the user without omission. Generation server 400 then creates a job history document based on the job history information. Generation server 400 causes the screen to display a request sentence, “Job history document was created. Please check the document.” (step S7). Further, generation server 400 presents the created job history document to the user (step S8). The user checks the job history document on the screen of user device 500.

In particular, generation server 400 diverges the interaction between generation server 400 and the user such that all of the user's job histories are acquired without omission in terms of STAR (Situation, Task, Action, Result).

Step S3 is an example of an inquiry for acquiring job history information corresponding to “Situation” from the user. Further, step S5 is an example of an inquiry for acquiring job history information corresponding to “Task” from the user. Although not shown in FIGS. 9 and 10, “Action” relates to a method by which the user overcomes “Situation” or “Task”. Further, “Result” relates to an outcome obtained by the user's “Action”.

Interaction program 411 includes parameters for causing the interaction to diverge in terms of STAR (Situation, Task, Action, Result). Such parameters are designed, for example, by a system administrator of generation server 400.

In addition to or instead of the interaction in a chat format, generation server 400 may permit the user to transmit a comma separated value (CSV) file or the like related to the job history information from user device 500 to generation server 400.

The following describes some examples of “diverging (diverge)”. For example, when the information acquired from a user is expanded into a sentence, a situation may occur in which the number of characters in the sentence is insufficient for the number of characters defined in a necessary description item. More specifically, the characters in the answer obtained in response to a question “what working environment you work in?” may not reach a prescribed number of characters (for example, 100 or more characters). In such a case, generation server 400 asks the user an additional question, “how the relation with your direct supervisor was?” or an additional question, “how the relation with your coworker was?”.

Alternatively, if the answer obtained from the user is short of specific details, generation server 400 asks the user an additional question. For example, if the reason is not clarified from the user's answer, generation server 400 asks the user an additional question. For example, if the answer “the team faced a manpower shortage . . . ” is obtained from the user but a “keyword” and the like indicating the reason of the manpower shortage is not included in the user's answer, generation server 400 asks the user an additional question such as “what caused a manpower shortage?”.

If the information about the “reason” is insufficient in the answer obtained from the user, generation server 400 may organize the information through use of large language model 430, and then present options for the reason to the user. For example, it is assumed that the user answers, “the team faced a manpower shortage and had a large amount of cases to be handled. Since the account manager has set an unreasonable deadline, the team also felt stress and had decreased motivation.”.

In this case, generation server 400 determines that the answer is insufficient, for example, as (a) the reason for a manpower shortage and (b) the reason for the user having a large amount of cases to be handled. Then, generation server 400 presents options to the user in order to obtain respective reasons.

In order to obtain “(a) the reason for a manpower shortage”, generation server 400 may make an inquiry, for example, “is there any reason for a manpower shortage among the following options? (you can select more than one option)”, and also may present, to the user, options “A: there are only a few entries even under recruitment”, “B: orders abruptly increased”, “C: many members quit”, and “D: others (free description)”.

In order to obtain “(b) the reason for the user having a large amount of cases to be handled”, generation server 400 may make an inquiry, for example, “is there any reason for having a large amount of cases to be handled among the following options? (you can select more than one option)”, and also may present, to the user, options “A: due to lack of information cooperation between the sales department and the development department, the number of received cases was excessively large with respect to the number of developers”, “B: the account manager lacks management capability”, “C: the development members lack skills”, and “D: others (free description)”.

The user may select three options A, B, and C as an answer to the above-mentioned (a), and may select two options A and B as an answer to the above-mentioned (b).

As a result, generation server 400 can extract a larger number of pieces of satisfactory information about the reasons for the above-mentioned (a) and (b) from the user. For example, the information acquired from the user before asking the user an additional question is “the team faced a manpower shortage and had a large amount of cases to be handled. Since the account manager has set an unreasonable deadline, the team also felt stress and had decreased motivation.”.

By making an additional question about the above-mentioned (a) and (b) in response to the user's answer, generation server 400 can extract, from the user, information stating, “due to lack of information cooperation between the sales department and the development department, the number of received cases was excessively and abruptly increased with respect to the number of developers, and the account manager lacks management capability, so that we could not handle all the cases. Since we have received a large number of orders and our working hours were excessively long, members quit one after another, which accelerated the manpower shortage. Further, there were only a few entries even under recruitment for mid-career employment in order to obtain work-ready personnel.”.

### Example of Interaction (In Case of Registration in Dictionary)

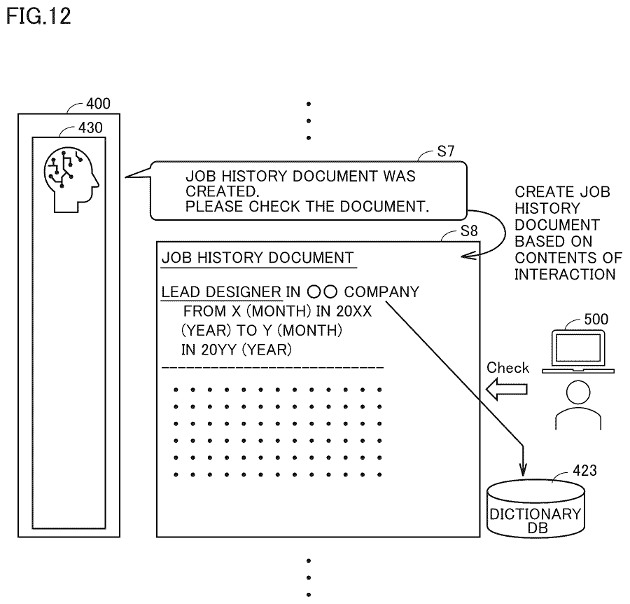

FIGS. 11 and 12 are diagrams each showing an example of an interaction (registration in dictionary) conducted between generation server 400 and the user. The following describes an operation of generation server 400 performed when generation server 400 detects a term to be registered into dictionary database 423 in the interaction shown in FIGS. 9 and 10 described above.

As shown in FIG. 11, generation server 400 detects the “lead designer” in the sentence input in step S2 as a term whose meaning is likely to be erroneously recognized. In this case, generation server 400 causes the screen to display an inquiry sentence, “does the lead designer mean ○○○○○○?” (step S2a).

In response to the inquiry in step S2a, the user answers, “No, it means ××××××.” (step S2b). In response to the answer in step S2b, generation server 400 causes the screen to display a sentence, “I see.” (step S2c). Further, in step S2c, generation server 400 registers the term “lead designer” and its meaning as a set into dictionary database 423.

Then, generation server 400 continues to interact with the user, and acquires job history information necessary for creating a job history document from the user without omission. Generation server 400 then creates a job history document based on the job history information. Generation server 400 causes the screen to display a request sentence, “Job history document was created. Please check the document.” (step S7). Further, generation server 400 presents the created job history document to the user (step S8).

As shown in FIG. 12, the term “lead designer” described in the job history document is underlined. The user understands that the underlined term is linked to the dictionary. When the user clicks on the term displayed on the screen with a mouse or the like, the meaning of the term registered in dictionary database 423 is displayed on the screen. On the screen of user device 500, the user checks the job history document including links to the dictionary. Generation server 400 registers the job history document approved by the user into user database 421, the job history document being associated with the user's member ID.

The job history document registered in user database 421 is transmitted to recruiter device 200 in response to the user's request. Recruiter device 200 causes recruiter device 200 to display the job history document including links to the dictionary. When a recruiter clicks on a term displayed on the screen with a mouse or the like, the meaning of the term registered in dictionary database 423 is displayed on the screen. Thereby, the recruiter can accurately grasp the meaning of the term described in the job history document.

### Function of Generation Server

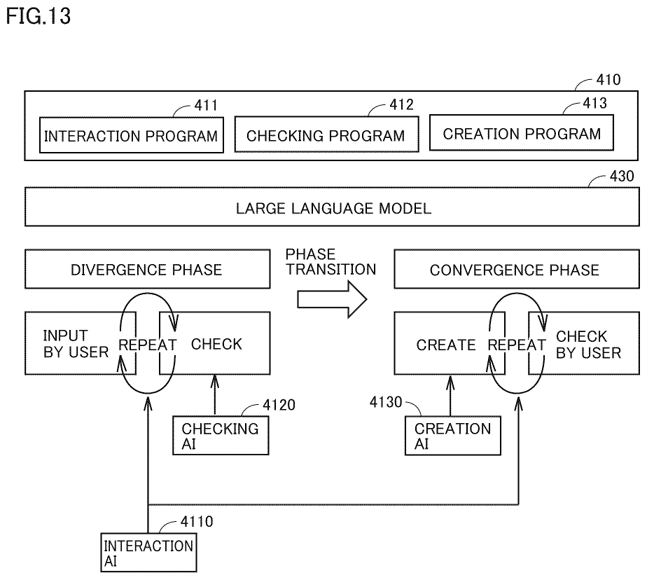

FIG. 13 is a diagram for illustrating a content of a process executed by generation server 400 in terms of a divergence phase and a convergence phase.

Generation server 400 has large language model 430 and program 410 (interaction program 411, checking program 412, and creation program) that executes a process for assisting creation of a job history document through use of large language model 430. As shown in FIG. 13, the process for assisting creation of a job history document is divided into a divergence phase and a convergence phase.

A combination of interaction program 411 and large language model 430 constitutes “interaction artificial intelligence (AI) 4110”. Interaction AI 4110 acquires a large number of pieces of job history information necessary for creating a job history document from the user. Further, interaction AI 4110 inquires of the user whether or not the created job history document satisfies the user's intention.

A combination of checking program 412 and large language model 430 constitutes a “checking AI 4120.” Checking AI 4120 checks that all the pieces of job history information corresponding to the necessary description items necessary for creating a job history document have been acquired without omission.

A combination of creation program 413 and large language model 430 constitutes a “creation (summarization) AI 4130”. Creation (summarization) AI 4130 creates a job history document according to a job history document format defined in advance.

In the divergence phase, while interacting with the user in a chat format, interaction AI 4110 acquires, from the user, job history information related to the necessary description items for a job history document. At this time, interaction AI 4110 controls the interaction such that the interaction diverges in terms of “STAR (Situation, Task, Action, Result)” according to the parameters designed by a system administrator.

In the divergence phase, checking AI 4120 reads the job history document format. The job history document format includes necessary description items necessary for creating a job history document. Checking AI 4120 checks that all the pieces of job history information corresponding to the necessary description items necessary for creating a job history document have been acquired without omission. If the job history information is insufficient, checking AI 4120 instructs interaction AI 4110 to continue the interaction about the insufficient job history information.

Interaction AI 4110 stores an interaction history. Thus, upon receipt of an instruction from checking AI 4120 to continue the interaction, interaction AI 4110 does not have to redo the interaction that has already ended, but can continue the interaction from somewhere in the middle of the previous interaction.

In the divergence phase, a divergence-type interaction by interaction AI 4110 and checking by checking AI 4120 are repeated until all the pieces of job history information corresponding to the necessary description items necessary for creating a job history document are acquired without omission.

After the divergence phase ends, generation server 400 transitions to a convergence phase. In the convergence phase, creation AI (summarization AI) 4130 has a function of organizing the acquired information into a prescribed format. More specifically, creation AI 4130 creates a job history document according to a job history document format defined in advance. Interaction AI 4110 presents the created job history document to the user. The user checks the job history document. If the user determines that the job history document does not satisfy the user's intention, the user instructs interaction AI 4110 to make a correction. In this case, creation AI 4130 corrects the job history document based on the correction instruction from the user. Interaction AI 4110 presents the corrected version to the user. The user checks the job history document.

In the convergence phase, creation (correction) of the job history document by creation AI 4130 and the interaction between interaction AI 4110 and the user are repeated until the job history document intended by the user is created.

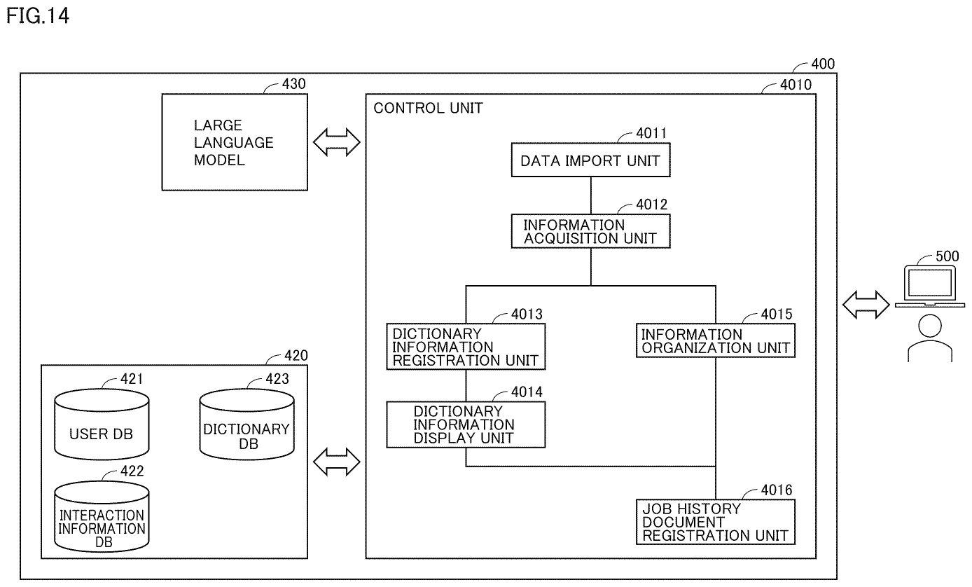

FIG. 14 is a diagram showing a functional configuration of generation server 400. As shown in FIG. 14, generation server 400 includes a control unit 4010. Control unit 4010 is implemented by processor 401, memory 402, and communication interface 404 shown in FIG. 3.

Through use of large language model 430, control unit 4010 may function as interaction AI 4110, checking AI 4120, and creation AI 4130 shown in FIG. 13. Control unit 4010 accesses database 420 to execute a process related to support for creating a job history document.

Control unit 4010 includes a data import unit 4011, an information acquisition unit 4012, a dictionary information registration unit 4013, a dictionary information display unit 4014, an information organization unit 4015, and a job history document registration unit 4016.

Data import unit 4011 imports the job history information already possessed by the user into interaction AI 4110. For example, data import unit 4011 can receive the job history information in a prescribed file format from the user via user device 500. Control unit 4010 uses the imported job history information for creating a job history document. In this way, by utilizing the job history information already possessed by the user, the cost for interaction of interaction AI 4110 can be reduced.

Information acquisition unit 4012 acquires job history information from the user through use of interaction AI 4110. Through use of checking AI 4120, information acquisition unit 4012 checks that all the pieces of job history information corresponding to the necessary description items necessary for creating a job history document have been acquired without omission.

Dictionary information registration unit 4013 registers, into dictionary database 423, specific terms obtained during the interaction between the user and interaction AI 4110. In this case, a specific term may be, for example, information specific to a certain organization such as a company.

If a term registered in dictionary database 423 is described in the job history document, dictionary information display unit 4014 displays, in a link format, the term described in the job history document. Information organization unit 4015 creates a job history document in a prescribed format through use of creation AI 4130.

Job history document registration unit 4016 stores the created job history document in user database 421. In particular, if a term registered in dictionary database 423 is described in the job history document, job history document registration unit 4016 generates a link that associates the term described in the job history document with the meaning of the term registered in dictionary database 423, and then, stores the job history information in user database 421.

### Processing Procedure of Control Unit 4010

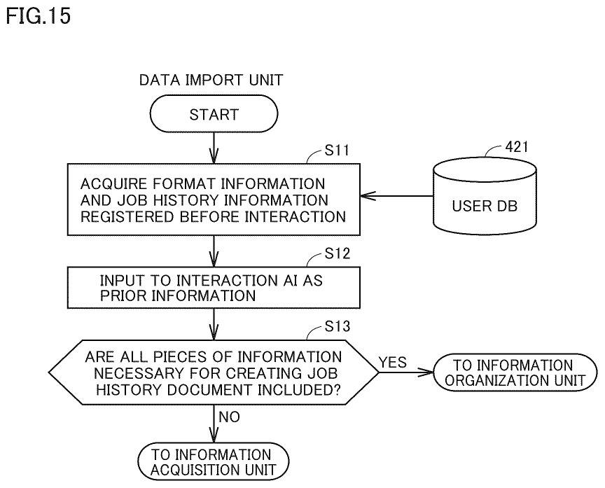

Then, referring to FIGS. 15 to 20, an example of a processing procedure of control unit 4010 included in generation server 400 will be described. As a processing procedure of control unit 4010, the following describes a processing procedure of each of data import unit 4011, information acquisition unit 4012, dictionary information registration unit 4013, dictionary information display unit 4014, information organization unit 4015, and job history document registration unit 4016.

FIG. 15 is a flowchart showing a processing procedure of data import unit 4011. First, data import unit 4011 acquires, from user database 421, the format information of the job history document and the job history information registered before the interaction between interaction AI 4110 and the user (step S11). Step S11 is an example of a collection unit that collects job history information about the user's job history. Further, step S11 is an example of an acquisition unit that acquires format information including necessary description items for a job history document.

The “job history information registered before the interaction between interaction AI 4110 and the user” is “job history information” shown in FIG. 8. In step S11, data import unit 4011 may read the user's job history information from a prescribed local file. The format information of the job history document includes necessary description items for the job history document, the order in which the necessary description items are arranged, and the like.

Next, data import unit 4011 inputs the job history information acquired in step S11 into interaction AI 4110 as prior information (step S12). Next, data import unit 4011 determines whether or not the job history information acquired in step S11 includes all the pieces of information necessary for creating a job history document (step S13). Data import unit 4011 calls checking AI 4120, and refer to the format information of the job history document to thereby make a determination in step S13.

If the job history information acquired in step S11 includes all the pieces of information necessary for creating a job history document, an interaction between interaction AI 4110 and the user is not required. Thus, if the job history information acquired in step S11 includes all the pieces of information necessary for creating a job history document, data import unit 4011 passes the process to information organization unit 4015. In information organization unit 4015, a job history document is created.

If the job history information acquired in step S11 does not include all the pieces of information necessary for creating a job history document, data import unit 4011 passes the process to information acquisition unit 4012.

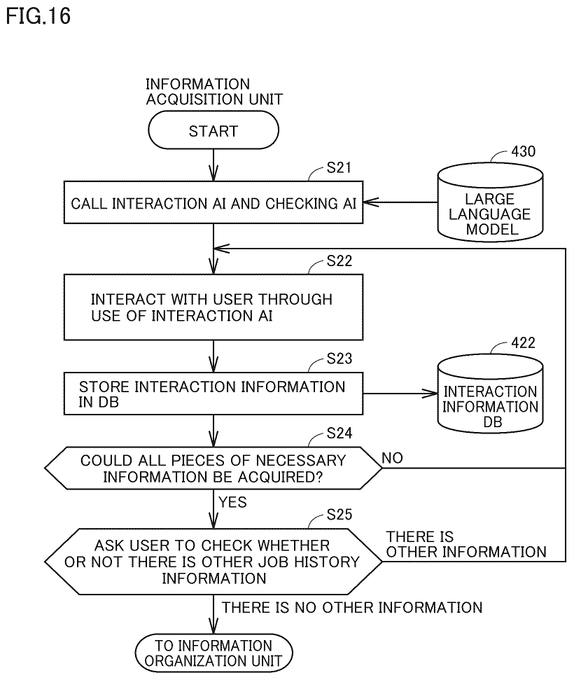

FIG. 16 is a flowchart showing a processing procedure of information acquisition unit 4012. First, information acquisition unit 4012 calls interaction AI 4110 and checking AI 4120 through use of large language model 430 (step S21).

Next, information acquisition unit 4012 interacts with the user through use of interaction AI 4110 (step S22). Thereby, information acquisition unit 4012 acquires interaction information (including job history information) from the user. Step S22 is an example of a collection unit that collects job history information about the user's job history. Further, step S22 is an example of an interaction unit that collects job history information by interacting with the user. Next, information acquisition unit 4012 stores the interaction information in interaction information database 422 (step S23). The interaction information is information indicating a history of the interaction with the user.

Next, based on the interaction information, information acquisition unit 4012 determines whether or not all the pieces of job history information corresponding to the necessary description items necessary for creating a job history document have been acquired without omission (step S24). At this time, information acquisition unit 4012 refers to the format information acquired in step S11 to make a determination in step S24. Note that information acquisition unit 4012 may acquire the format information from user database 421 in a step different from step S11. If not all the pieces of job history information corresponding to the necessary description items have been acquired without omission, information acquisition unit 4012 returns the process to step S22.

If all the pieces of job history information corresponding to the necessary description items have been acquired without omission, information acquisition unit 4012 asks the user to check whether or not there is other job history information (step S25). If there is other job history information, information acquisition unit 4012 returns the process to step S22. If there is no other job history information, information acquisition unit 4012 passes the process to information organization unit 4015. In information organization unit 4015, a job history document is created.

FIG. 17 is a flowchart showing a processing procedure of dictionary information registration unit 4013. First, dictionary information registration unit 4013 detects a word to be registered into the dictionary during an interaction between interaction AI 4110 and the user (step S31). Words to be registered into the dictionary include proper nouns, multiple-meaning word information, and the like. Words to be registered into the dictionary may be, for example, information specific to a certain organization such as a company. Next, dictionary information registration unit 4013 asks the user about the meaning of the word (step S32).

Next, dictionary information registration unit 4013 acquires an answer from the user (step S33). Next, dictionary information registration unit 4013 registers the word detected in step S31 and the meaning based on the user's answer into dictionary database 423 as dictionary information (step S34), and then, ends the process based on this flowchart. Step S34 is an example of a registration unit that registers the meaning of the term included in the job history information into the dictionary database.

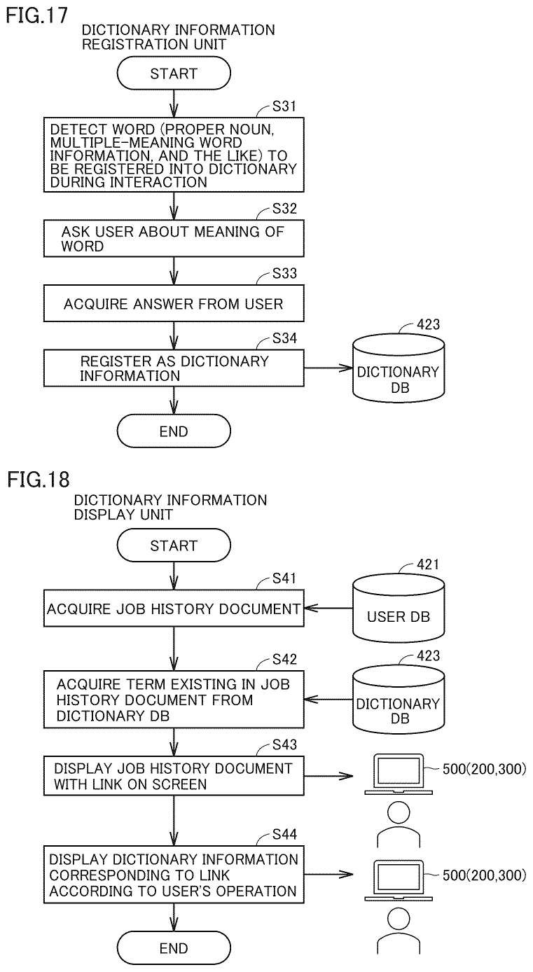

FIG. 18 is a flowchart showing a processing procedure of dictionary information display unit 4014. First, dictionary information display unit 4014 acquires the user's job history document from user database 421 (step S41). Next, dictionary information display unit 4014 acquires a term existing in the job history document from dictionary database 423 (step S42). Next, dictionary information display unit 4014 causes the screen of user device 500 to display the job history document associated with a link (step S43).

Next, dictionary information display unit 4014 causes the screen of user device 500 to display the dictionary information corresponding to the link according to the user's operation (step S44), and ends the process based on this flowchart. Dictionary information display unit 4014 is an example of a display unit that causes a display device to display a job history document. User device 500 is an example of a display device. In place of or in addition to user device 500, dictionary information display unit 4014 may cause a display device provided in generation server 400 to display a job history document.

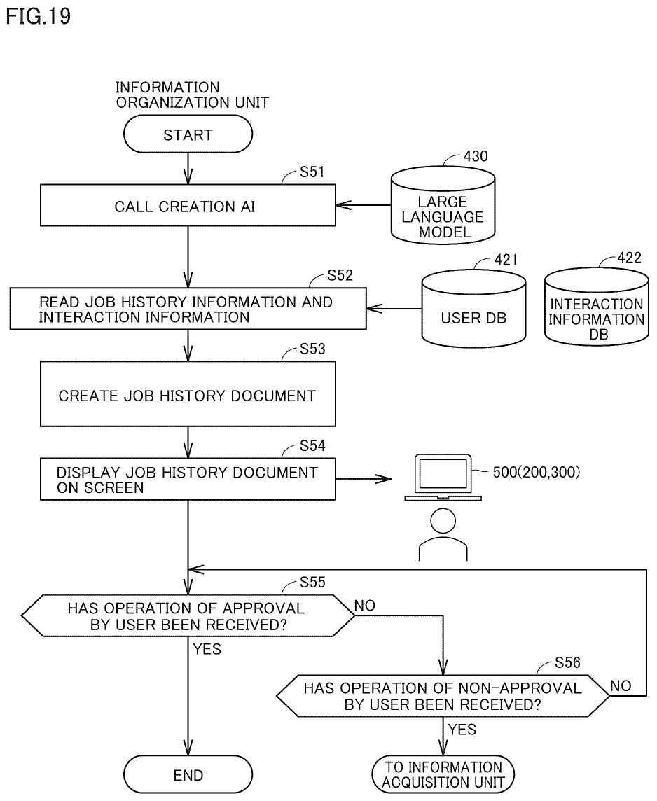

FIG. 19 is a flowchart showing a processing procedure of information organization unit 4015. First, information organization unit 4015 calls creation AI 4130 through use of large language model 430 (step S51).

Next, information organization unit 4015 reads the interaction information from interaction information database 422 (step S52). If the job history information registered in advance exists in user database 421, information organization unit 4015 reads the job history information from user database 421 in step S52.

Next, information organization unit 4015 creates a job history document from the interaction information (step S53). Further, if information organization unit 4015 has read the job history information from user database 421, it creates a job history document from the job history information and the interaction information in step S53. Step S53 is an example of a creation unit that creates a job history document.

Information organization unit 4015 refers to the format information acquired in step S11, and creates a job history document in a format according to the format information. Note that information acquisition unit 4012 may acquire the format information from user database 421 in a step different from step S11. Next, information organization unit 4015 causes the screen of user device 500 to display the job history document (step S54).

Next, information organization unit 4015 determines whether or not an operation of approval by the user has been received (step S55). If the operation of approval by the user has been received, information organization unit 4015 ends the process based on this flowchart.

If the operation of approval by the user has not been received, information organization unit 4015 determines whether or not an operation of non-approval by the user has been received (step S56). If the operation of non-approval by the user has not been received, information organization unit 4015 returns the process to step S55. If the operation of non-approval by the user has been received, information organization unit 4015 passes the process to information acquisition unit 4012. Information acquisition unit 4012 calls interaction AI 4110 again and interacts with the user to thereby acquire new interaction information from the user.

Note that information organization unit 4015 may not only acquire new interaction information from the user but also interact with the user again without changing the conditions applied before the interaction. In general, in a large language model, a plurality of answers (sentences) with different nuances may be generated for the same question and condition.

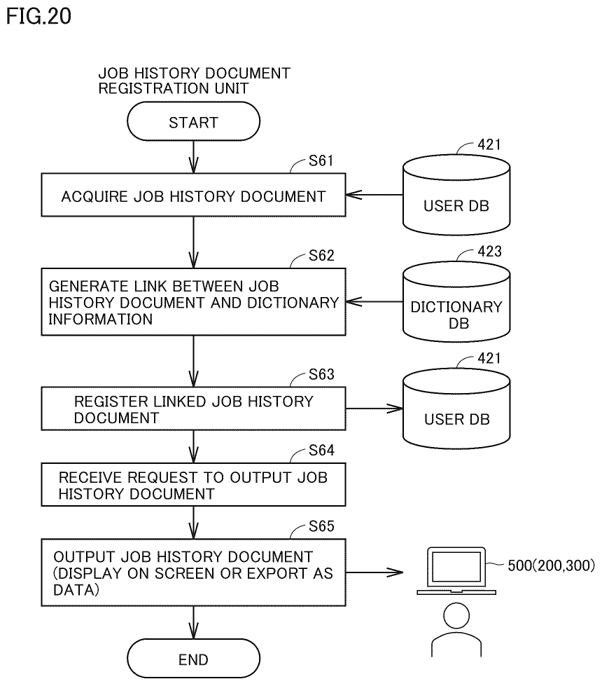

FIG. 20 is a flowchart showing a processing procedure of job history document registration unit 4016. First, job history document registration unit 4016 acquires the user's job history document from user database 421 (step S61). Next, job history document registration unit 4016 refers to dictionary database 423 to generate a link between the job history document and the dictionary information (step S62). Next, job history document registration unit 4016 stores the linked job history document in user database 421 (step S63).

Next, job history document registration unit 4016 receives a request from the user to output a job history document (step S64). Next, job history document registration unit 4016 outputs the job history document to user device 500 (step S65), and ends the process based on this flowchart. Note that user device 500 may cause the screen of user device 500 to display the job history document. Alternatively, user device 500 may store the data of the job history document in the memory until it receives an instruction from the user.

### Sequence of Process Performed by Matching System 1

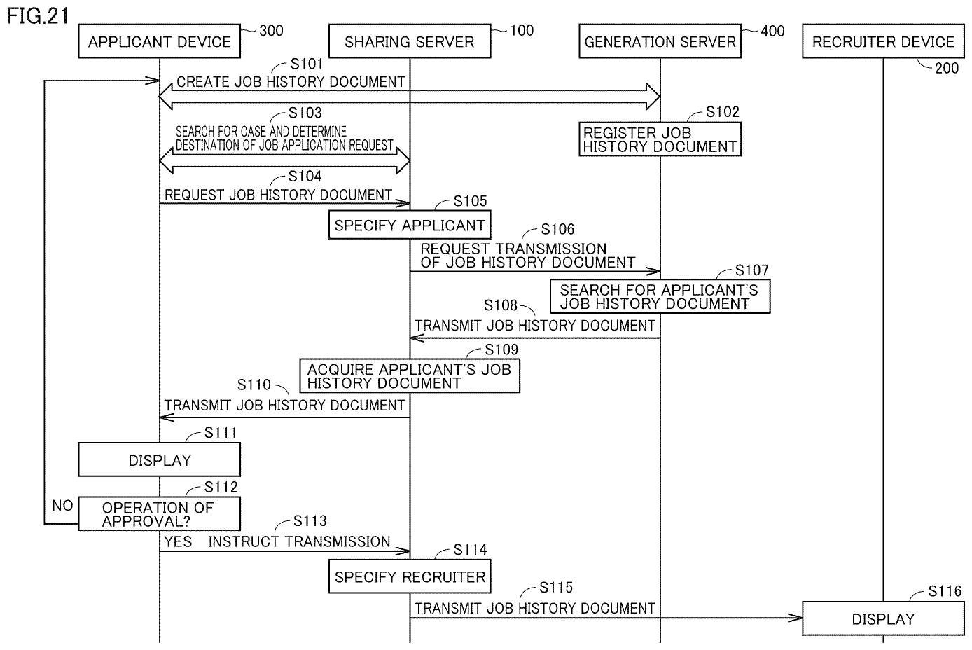

FIG. 21 is a timing chart showing a processing procedure of each of sharing server 100, recruiter device 200, applicant device 300, and generation server 400, each processing procedure being related to a job history document. The flow of the process of matching system 1 related to a job history document will be described with reference to the timing chart shown in FIG. 21.

First, an applicant accesses the generation server through applicant device 300 to create a job history document (step S101). Generation server 400 registers the created job history document into user database 421 (step S102). Since the detailed processing procedure in steps S101 and S102 has already been described with reference to FIGS. 15 to 20, the description thereof will not be repeated herein.

Next, the applicant accesses sharing server 100 through applicant device 300, searches for a recruitment case, and determines a destination of a job application request (step S103). Next, the applicant operates applicant device 300 to transmit a command for requesting the applicant's job history document from applicant device 300 to sharing server 100 (step S104). Sharing server 100 that has received the command specifies the applicant (step S105). More specifically, sharing server 100 specifies the applicant's member ID.

Next, sharing server 100 transmits a command for requesting transmission of the job history document to generation server 400 (step S106). This command includes the applicant's member ID. Generation server 400 searches user database 421 for the applicant's job history document based on the member ID included in the command (step S107).

Next, generation server 400 transmits, to sharing server 100, the job history document detected as a result of the search (step S108). Thereby, sharing server 100 acquires the applicant's job history document (step S109). Next, sharing server 100 transmits the acquired job history document to applicant device 300 (step S110).

Applicant device 300 causes the screen of applicant device 300 to display the received job history document (step S111). If the term registered in dictionary database 423 is described in the job history document, the job history document with a link to the dictionary is displayed on the screen.

The applicant checks that there is no problem in the job history document displayed on the screen. For example, the applicant checks that the job history document does not include information and the like to be updated. If there is no problem in the job history document, the applicant performs an operation of approval using a keyboard and the like. If there is a problem in the job history document, the applicant performs an operation of non-approval using a keyboard and the like.

Applicant device 300 determines whether or not an operation of approval has been detected (step S112). If applicant device 300 detects an operation of non-approval instead of the operation of approval, it returns the process to step S101. In this case, a process of creating a job history document is executed again. However, it is desirable that, instead of executing the process of creating a job history document from scratch, generation server 400 interacts with the applicant regarding the items to be corrected, and then, corrects the relevant description in the job history document.

If applicant device 300 detects the operation of approval, it transmits a command to sharing server 100 to instruct transmission of the job history document (step S113). Sharing server 100 specifies a recruiter to which the job history document is to be transmitted (step S114). For example, based on the destination of the job application request that has been determined in step S103, sharing server 100 specifies a recruiter to which the job history document is to be transmitted.

Next, sharing server 100 transmits the job history document to recruiter device 200 (step S115). Recruiter device 200 causes the screen of recruiter device 200 to display the received job history document (step S116). If a term registered in dictionary database 423 is described in the job history document, the job history document with a link to the dictionary is displayed on the screen. The recruiter grasps the applicant's job history based on the job history document. When an applicant clicks, with a mouse, on a term included in the description of the job history document and registered in the dictionary, the meaning of the term is displayed on recruiter device 200. Therefore, even when an incomprehensible term such as a term used exclusively in a company for which the applicant works is included in the job history document, the recruiter can understand the meaning of the term.

In FIG. 21, sharing server 100 and generation server 400 may be configured as one server. In other words, the function of generation server 400 may be provided in sharing server 100, or the function of sharing server 100 may be provided in generation server 400. Steps S110 and S115 are examples of an output unit configured to output a job history document created by the creation unit to the user device.

As described above, according to the present embodiment, the user can be assisted such that the user can create a job history document in which items related to necessary description items are described without omission and without redundant description. In addition, according to the present embodiment, the user can be assisted such that the user can create a job history document appropriately reflecting the user's job history irrespective of the user's document creation capability. Further, according to the present embodiment, the following effects are achieved.

a. Irrespective of the user's document creation capability, the user can be provided with a job history document in which the user's skills, experiences, and the like are appropriately expressed.

b. A wide variety of pieces of user's job history information can be collected without omission.

c. Providing the user with an interactive interface can reduce the burden on the user for appropriately extracting the job history information.

d. The burden on the user for creating a job history document can be reduced.

e. Since the job history document is created in a uniform format, the efficiency in managing and searching for a large number of job history documents can be enhanced.

f. An interface for creating a high-quality job history document can be provided to a user who feels it difficult to keep motivation for a complicated action of creating a job history document, such as an employee who applies for an in-house project or an employee who wishes to do a side business outside the company.

g. If a term registered in dictionary database 423 is described in the job history document, the job history document with a link to the dictionary is displayed on the screen. Thus, if an incomprehensible term is included in the job history document, a recruiter can understand the meaning of the term.

A part of the configuration of generation server 400 may be formed by a device separate from generation server 400. For example, at least one of a plurality of databases included in database 420 and large language model 430 may be located on a cloud different from generation server 400. In this case, generation server 400 and the cloud may be communicably connected to each other via a network.

### Modifications

In the example described in the present embodiment, generation server 400 is disposed in matching system 1. However, a generation server for generating a job history document may be constructed independently of matching system 1. An example of a generation server that generates a job history document independently of matching system 1 will be described.

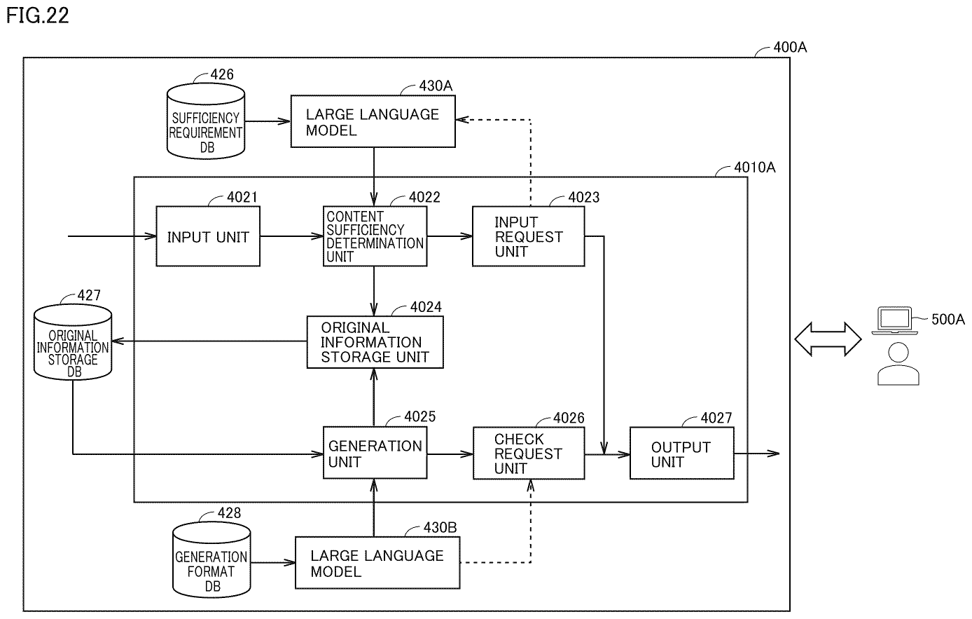

FIG. 22 is a diagram showing a functional configuration of a generation server 400A according to a modification. Similarly to generation server 400, generation server 400A has configurations of a processor, a memory, a communication interface, a storage, and the like, and includes a control unit 4010A implemented by these configurations.

Generation server 400A is communicably connected to a user device 500A used by a user via the Internet or the like.

Generation server 400A includes a sufficiency requirement database (sufficiency requirement DB) 426, an original information storage database (original information storage DB) 427, a generation format database (generation format DB) 428, and large language models 430A and 430B. These databases and large language models are configured in a storage of generation server 400A.

Similarly to large language model 430, large language models 430A and 430B are natural language processing models trained using a large pieces of text data. In the present disclosure, BERT (registered trademark) (LaMBDA) from Google.com, GPT-4 from OpenAI, or the like may be employed as a large language model. In the present disclosure, a large language model is an example of a natural language processing algorithm. As the natural language processing algorithm, a language model other than the large language model may be employed. As the natural language processing algorithm, a model generated by machine learning such as pattern matching may be employed. Further, as the large model, one large language model may be used in place of using two large language models 430A and 430B. For example, large language model 430 may be used.

As shown in FIG. 22, control unit 4010A includes an input unit 4021, a content sufficiency determination unit 4022, an input request unit 4023, an original information storage unit 4024, a generation unit 4025, a check request unit 4026, and an output unit 4027.

Input unit 4021 receives information input by the user through user device 500. The information input by the user includes job history information. Input unit 4021 may receive job history information, for example, in a chat format. Note that input unit 4021 may receive job history information in a voice file format and other file formats. When GPT-3 or the like is used as a large language model and a UI in a chat format represented by ChatGPT is used, a file may be attached to a chat. In this case, generation server 400 may be provided with a function of converting a file into a document in a chat-format.

Output unit 4027 outputs various pieces of information to user device 500. Output unit 4027 may output not only the information in a chat format but also other files such as voice to user device 500. When control unit 4010A interacts with the user in a chat format, input of information to input unit 4021 and output of information from output unit 4027 are repeatedly performed.

The information registered in sufficiency requirement database 426 is information about a requirement (sufficiency requirement) for large language model 430A to determine that all the pieces of job history information corresponding to the necessary description items necessary for creating a job history document have been acquired without omission.

The information about a plurality of types of sufficiency requirements may be registered in sufficiency requirement database 426. In this case, control unit 4010A may transmit a plurality of types of sufficiency requirements to user device 500A to cause the user to select the user's preferable sufficiency requirement. Alternatively, control unit 4010A may receive the sufficiency requirement set by the user via user device 500A.

Further, by using the contents of a large number of sufficiency requirements as training data, control unit 4010A may generate a trained model that functions as AI. In this case, the generated trained model may be used in place of a large language model. Further, a sufficiency requirement may be used for Prompt of existing large language model 430A. The sufficiency requirement may include, for example, specific information such as the number of companies that the user wishes to include in the job history document.

Through use of large language model 430, content sufficiency determination unit 4022 determines whether or not the information obtained by input unit 4021 satisfies a sufficiency requirement. If content sufficiency determination unit 4022 determines that the information obtained by input unit 4021 does not satisfy the sufficiency requirement, it instructs input request unit 4023 to acquire additional information. If content sufficiency determination unit 4022 determines that the information obtained by input unit 4021 satisfies the sufficiency requirement, it outputs the information obtained by input unit 4021 to original information storage unit 4024.

Based on the instruction from content sufficiency determination unit 4022, input request unit 4023 instructs large language model 430A to continue the interaction with the user such that additional information (insufficient information) is obtained from the user. If a plurality of pieces of additional information are required, large language model 430A may interact with the user such that the plurality of pieces of additional information are collectively acquired, or large language model 430A may interact with the user such that the plurality of pieces of additional information are sequentially acquired. For example, if information A, information B, and information C are insufficient, large language model 430A may first inquire of the user about information A.

Note that large language model 430A may automatically generate an interaction rule for prompting the user to input additional information, or may select an interaction rule from among options set in advance.

Original information storage unit 4024 temporarily stores job history information as a basis for generating a job history document. Original information storage unit 4024 outputs the temporarily stored job history information to original information storage database 427. Original information storage database 427 registers the job history information. Generation unit 4025 creates a job history document using the job history information registered in original information storage database 427. Note that generation unit 4025 may have a function of creating a job history document without waiting for the determination by content sufficiency determination unit 4022.

For example, if the user has a draft of the job history document at hand, the user may only desire to have a fair copy of the job history document or to format the job history document. In this case, input unit 4021 may receive draft data of the job history document from the user via user device 500. Further, input unit 4021 may register the received data into original information storage database 427. Generation unit 4025 may create a job history document based on the draft data registered in original information storage database 427.

In generation format database 428, a format necessary for large language model 430B to generate a job history is registered.

Note that a plurality of types of formats may be registered in generation format database 428. In this case, control unit 4010A may transmit a plurality of types of formats to user device 500A to cause the user to select the user's preferable format. Alternatively, control unit 4010A may receive a format set by the user via user device 500A.

Further, control unit 4010A may generate a trained model that functions as AI using a large number of formats as training data. In this case, the generated trained model may be used in place of a large language model. Further, a format may be used for Prompt of existing large language model 430A.

Generation unit 4025 generates a job history document through use of large language model 430B. The format registered in generation format database 428 is input to large language model 430B. Generation unit 4025 refers to original information storage database 427 to create, in a predefined format, a job history document in which the job history information is reflected. In place of generation unit 4025, large language model 430B may create a job history document. The job history document generated by generation unit 4025 is output to check request unit 4026.

Check request unit 4026 requests the user to check the job history document. Check request unit 4026 transmits the job history document to user device 500 via output unit 4027. The user checks the contents of the job history document displayed on user device 500. Note that check request unit 4026 may divide the contents of the job history document into a plurality of items and request the user to check the contents of the job history document for each item.

For example, if the job history document includes descriptions regarding companies A and B, check request unit 4026 may request the user to check the contents of the description regarding company A and subsequently request the user to check the contents of the description regarding company B. It is needless to say that check request unit 4026 may request the user to collectively check all the contents in the job history document. Large language model 430B may automatically generate an interaction rule applied when the user checks the job history document, or may select an interaction rule from among options set in advance.

A part of the configuration of generation server 400A may be configured separately from generation server 400A. For example, at least one of sufficiency requirement database 426, original information storage database 427, generation format database 428, and large language models 430A and 430B may be configured separately from generation server 400A. In this case, a device configured separately from generation server 400A should only be communicably connected to generation server 400A via a network.

### Modifications Regarding Use of IPC Classification

In a job history document of an engineer, in general, engineer's skills are described in detail. With the rapid development of IT-related technology, technologies in new fields that have not been known so far come into existence one after another, and the technologies have been rapidly diversifying. On the other hand, the user's skills differ in granularity by the field. Thus, the uniformity in the descriptions about skills in the job history document have been becoming lost. This hinders a recruiter from analyzing the applicant's job history document.

Such a problem occurs also in a company. It is important for a person in charge of employee evaluation to grasp employees' skills and systematically organize their skills. It is considered that this allows the technical resources in the company to be utilized as much as possible. However, due to the above-described circumstances, even if each employee is mandated to submit a job history document, it is difficult to manage the skills of all the employees in a unified manner on a certain criterion based on the submitted job history documents.

Thus, there is a need for an indicator that allows classification of various technical skills on a uniform criterion. It is conceivable to use International Patent Classification (IPC) as such an indicator. IPC is an internationally unified technical classification for classifying inventions filed as applications for patent. By using IPC, technologies can be hierarchically classified specifically into a “section”, a “subsection”, a “class”, a “subclass”, a “main group”, and a “subgroup”.

IPC is an indicator originally used to classify patent literatures. It is however considered that, by utilizing IPC as an indicator for classifying engineers' skills, the skills of engineers of various technologies including the latest technologies can be classified on a uniform criterion. It should be noted that, since IPC is a highly specialized classification indicator used in the patent industry, it is difficult for a user unfamiliar with IPC to accurately select an IPC corresponding to his/her skill from among a large number of options of IPCs.

Thus, a system proposed herein is for allowing a user to select an appropriate IPC corresponding to his/her skill through an interaction with generation server 400. Herein, an IPC is assumed as an example of a necessary description item or format information of a job history document. Also, the user's history information necessary for acquiring an IPC corresponding to the user's skill is assumed as an example of the job history information. Generation server 400 interacts with the user through use of a natural language processing algorithm to collect user's job history information necessary for acquiring an IPC.

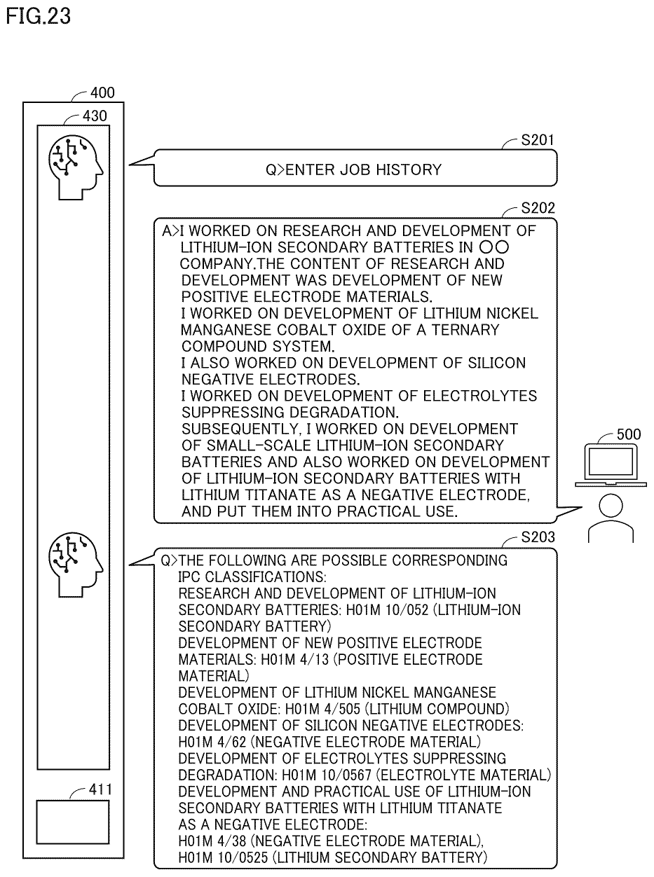

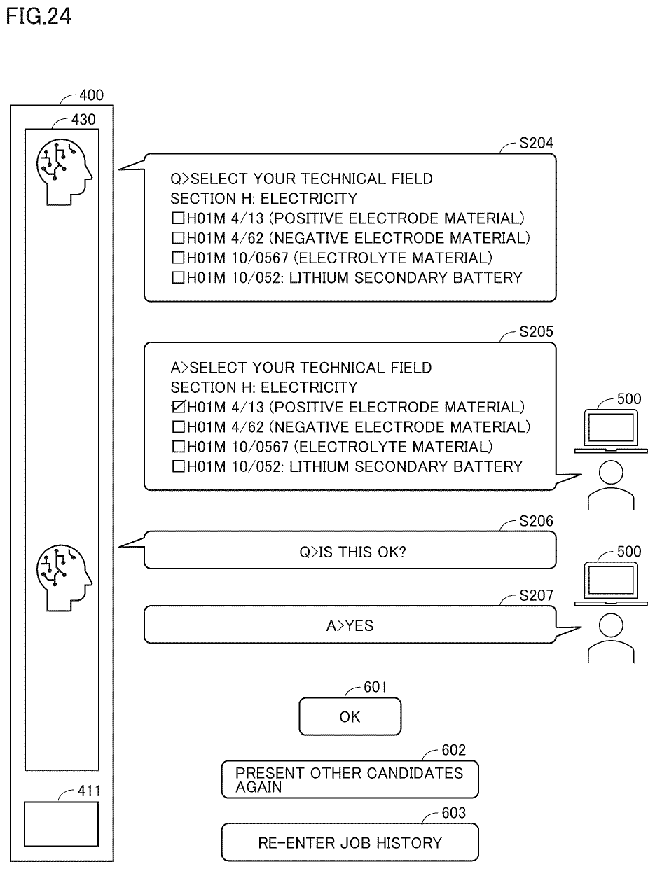

FIGS. 23 and 24 are diagrams each showing another example of the interaction conducted between generation server 400 and the user. FIGS. 23 and 24 each show an example in which an appropriate IPC corresponding to the user's skill is acquired by generation server 400 through an interaction with the user.

First, generation server 400 causes the screen to display a request sentence, “enter job history.” (step S201). In response to the request in step S1, the user gives an answer of his/her job history (step S202). In step S202, for example, the user gives an answer of his/her job history related to the development of a lithium-ion secondary battery.

Based on the answer in step S2, generation server 400 organizes the information through use of large language model 430, and presents, to the user, the IPC that may correspond to the user's skill (step S203). In step S203, for example, one “IPC” or a plurality of “IPCs” is or are presented to the user, the “IPC(s)” corresponding to respective pieces of information such as “research and development of lithium-ion secondary batteries”, “development of new positive electrode materials”, “development of lithium nickel manganese cobalt oxide”, “development of silicon negative electrodes”, “development of electrolytes suppressing degradation”, and “development and practical use of lithium-ion secondary batteries with lithium titanate as a negative electrode” that have been obtained by an interaction.

Next, from among the IPCs presented in step S203, generation server 400 presents some IPCs to the user as selection candidates (step S204). At this time, generation server 400 may present the selection candidates together with check boxes as shown in FIG. 24. The user considers whether or not the selection options include an IPC that seems to be appropriate. If the selection options include an IPC that seems to be appropriate, the user marks the check box corresponding to that IPC and sends back an answer. In this case, a button 601 as shown in FIG. 24 may be displayed on the screen of user device 500. After marking the check box, the user clicks on button 601. When the operation of clicking on button 601 is detected, generation server 400 fixes the IPC to be described in the user's job history document based on the user's answer.

In this way, based on the job history acquired through the interaction, generation server 400 suggests, to the user, an IPC considered to be relevant from among a large number of IPCs. Thus, the user can select an IPC related to his/her skill even if the user does not have expertise on the IPC. Although an example in which a “subgroup” is used is shown in this case, a symbol of an upper hierarchy level such as a “subclass” or a “group” may be used depending on the granularity to be classified. Further, the explanation sentence about a “subgroup” may be displayed additionally together with explanations about a “subclass”, a “group”, a “main group”, and the like, or a button with a mark “?” and the like may be added such that the contents of the upper hierarchy level can be checked as necessary.

In the example described above, the IPC related to the user's technical field is selected by the user, in which case the IPC presented to the user may be any one of a “section”, a “subsection”, a “class”, a “subclass”, a “main group”, and a “subgroup”. For example, like “H01: Electric Elements” and the like, a subclass may be presented to the user. Further, together with a classification symbol, a name and the like of a technical field classified by this classification symbol may be presented to the user.

If the selection options proposed in step S205 do not include an appropriate IPC, the user can request generation server 400 to present other candidates again or to allow the user to re-enter the job history from scratch. In this case, buttons 602 and 603 as shown in FIG. 24 may be displayed on the screen of user device 500.

If the operation of clicking on button 602 is detected, generation server 400 selects, from among the IPCs presented in step S203, an IPC different from those in the selection options presented in step S204, and newly presents the selected IPC to the user. If the operation of clicking on button 603 is detected, generation server 400 returns the process to step S204 and prompts the user to input the job history.

Further, IPC candidates may be automatically generated several times. Generation server 400 may generate different answers to the same sentence (or the same question). Thus, by automatically performing a process of IPC generation from step S202 several times before suggesting IPC candidates in step S204, the range of the IPC candidates can be expanded. This increases the possibility that the user can select an IPC suitable for the user.

As described above, generation server 400 supports the user's action to specify the IPC corresponding to the user's skill through the interaction between generation server 400 and the user. Note that the process in step S203 is not indispensable in the present embodiment. In other words, after detecting a plurality of IPCs considered to correspond to the user's skill through the interaction, generation server 400 may present some of the detected IPCs to the user in step S204 without executing the process in step S203.

Not only when receiving a request from the user to present other candidates again, but also in an autonomous manner, generation server 400 may present other candidates to the user. For example, generation server 400 may execute a process of creating option candidates several times and present the plurality of candidates to the user. In general, even if the content of the first inquiry and the content of the second inquiry are the same, the answers obtained from a large language model in response to the first and second inquiries may be different. Thus, by causing generation server 400 to execute the process of creating option candidates several times, a plurality of candidates having different viewpoints may be derived from generation server 400. If user's selection from each of these candidates can be obtained, generation server 400 can obtain a wider range of answers regarding an IPC from the user.

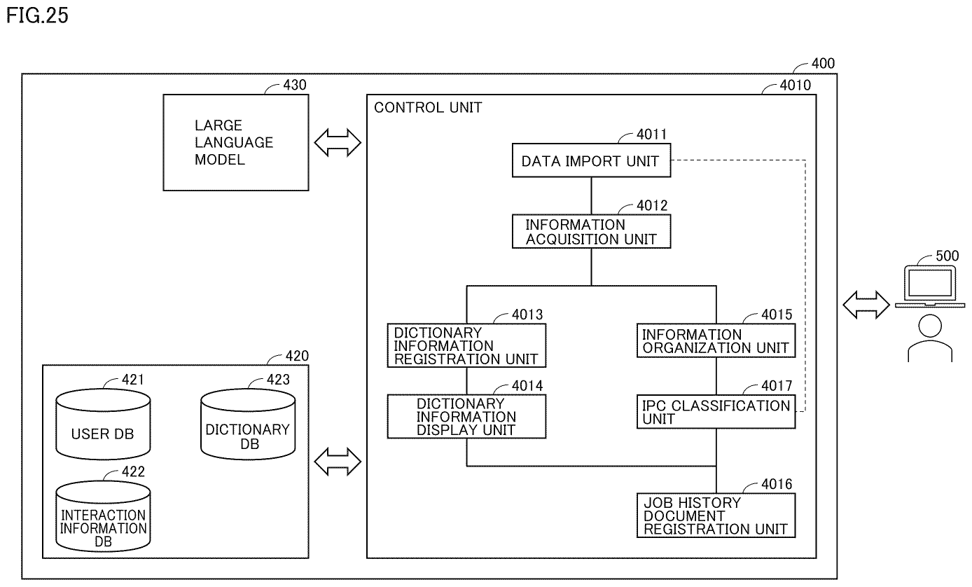

FIG. 25 is a diagram showing a functional configuration of generation server 400 including an IPC classification unit 4017. In the present modification, IPC classification unit 4017 is added to control unit 4010 of generation server 400 shown in FIG. 14. IPC classification unit 4017 determines the user's IPC to be described in the job history document. Based on the user's job history information obtained through an interaction, IPC classification unit 4017 can present, to the user, an IPC considered to correspond to the user's skill. Based on the job history information imported by data import unit 4011, IPC classification unit 4017 can further present, to the user, an IPC considered to correspond to the user's skill. After presenting a plurality of IPCs to the user, IPC classification unit 4017 determines an IPC suitable for the user's skill through the interaction. The determined IPC is taken into information organization unit 4015. Through use of creation AI 4130, information organization unit 4015 creates a job history document including the IPC in a prescribed format. Job history document registration unit 4016 stores the created job history document in user database 421.

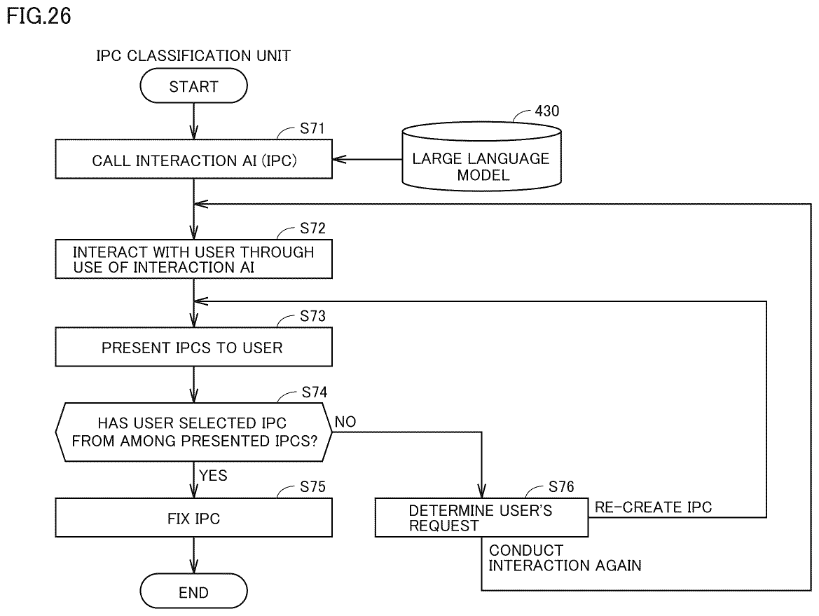

FIG. 26 is a flowchart showing a processing procedure of IPC classification unit 4017. First, IPC classification unit 4017 calls interaction AI 4110 through use of large language model 430 (step S71).

Next, IPC classification unit 4017 interacts with the user through use of interaction AI 4110 (step S72). Thereby, IPC classification unit 4017 acquires interaction information (including job history information) from the user. Step S72 is an example of a collection unit that collects job history information about the user's job history. Further, step S72 is an example of an interaction unit that collects job history information through an interaction with the user. The information related to IPCs may be stored in dictionary database 423. In this case, IPC classification unit 4017 may refer to dictionary database 423 to determine an IPC to be presented to the user.

Next, IPC classification unit 4017 presents, to the user, several IPCs considered to correspond to the user's skill (step S73). Next, IPC classification unit 4017 determines whether or not the user has performed an operation of selecting an IPC from among the presented IPCs (step S74).

If the user has not performed the operation of selecting an IPC, IPC classification unit 4017 determines the user's request (step S76). More specifically, if the user requests re-creation of an IPC, IPC classification unit 4017 returns the process to step S73, changes IPCs to be presented, and presents some IPCs to the user again. Such a process is executed, for example, when the operation of clicking on button 602 shown in FIG. 24 is detected. If the user makes a request to conduct an interaction again, IPC classification unit 4017 returns the process to step S72 and interacts with the user again. Such a process is executed, for example, when the operation of clicking on button 603 shown in FIG. 24 is detected.

For example, if the operation of clicking on button 601 shown in FIG. 24 is detected, IPC classification unit 4017 determines that the user performs an operation of selecting an IPC. In this case, based on the user's operation, IPC classification unit 4017 fixes the IPC to be described in the job history document (step S75), and ends the process based on this flowchart. Generation server 400 registers the IPC fixed in step S75 into user database 421 as a part of the job history information. Thus, the job history information includes the IPC. In this flowchart, steps S72 to S75 are an example of a collection unit that collects patent classification information related to the user's job based on the information acquired from the user by an interaction. As in steps S72 to S75, the collection unit presents a plurality of IPCs related to the user's job to the user based on the information acquired from the user through an interaction, and then fixes the IPC according to the user's selection as the user's job history information.

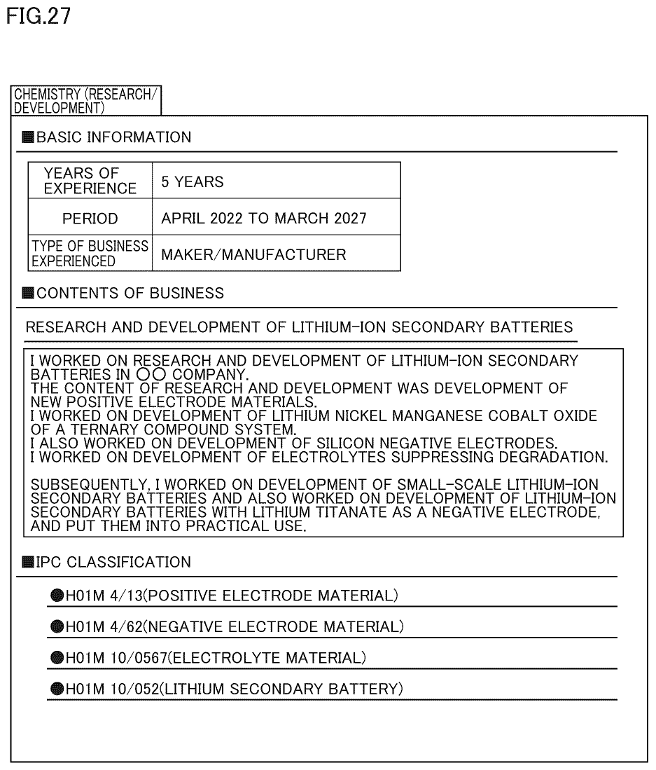

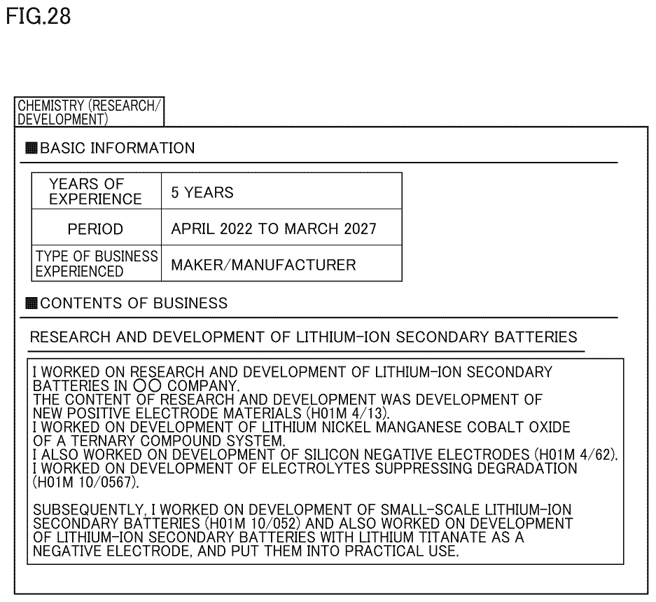

Some examples of a job history document will be hereinafter described with reference to FIGS. 27 to 30. FIGS. 27 to 30 are diagrams each showing an example of a job history document including IPC classification. The job history documents shown in FIGS. 27 to 30 include basic information, contents of business, and IPCs related to the contents of business. In particular, FIG. 27 shows a job history document in a format in which IPC items are listed separately from the items of the contents of business. On the other hand, FIG. 28 shows a job history document in a format in which corresponding IPCs are incorporated in the description of the contents of business.

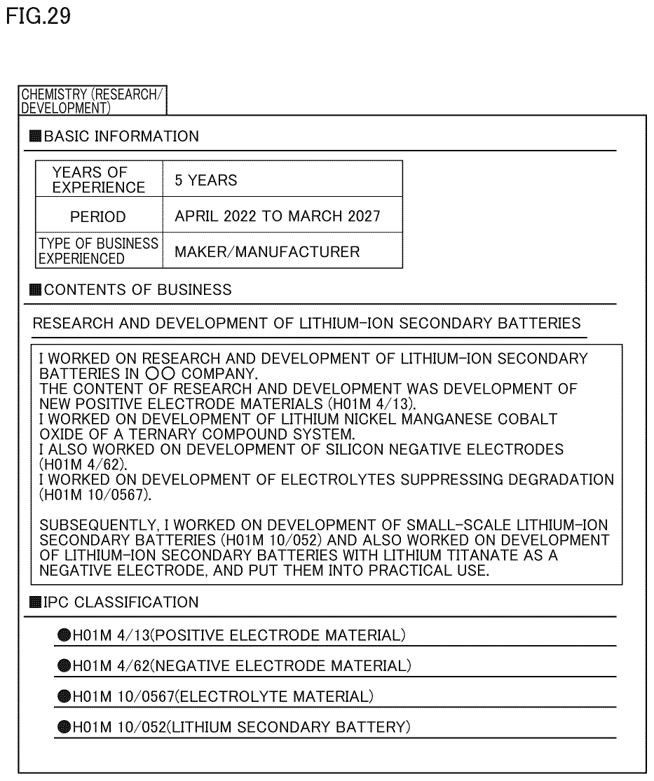

A format adoptable herein may be a format in which IPC items are listed separately from the items of the contents of business, and corresponding IPCs are incorporated into the description of the contents of business. FIG. 29 shows an example of a job history document created in such a format.

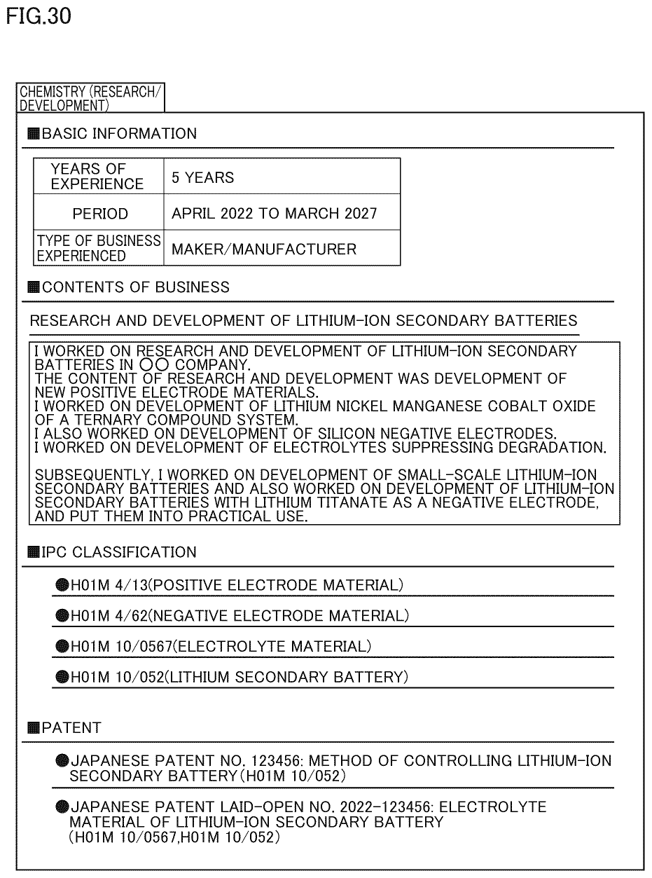

If there is a patent application filed by the user as an inventor, a patent item may be provided in the job history document as shown in FIG. 30. In the patent item, corresponding IPCs may be described together with patent information. By listing the user's patent information together with IPCs in the job history document in this way, the user can more strongly appeal his/her expertise.

In this way, IPCs corresponding to the user's skill can be described in various formats in the job history document. Generation server 400 associates the information about the job contents, the job experience, and the length of service with the IPCs, and stores the associated information in user database 421 as job history information. As shown in FIG. 30, when generation server 400 acquires the information about the user's patent, it stores, in user database 421, the patent information in association with the corresponding IPC as job history information. Further, generation server 400 stores the job history documents illustrated in FIGS. 27 to 30 in user database 421. Generation server 400 may cause the user to select a job history document format through an interaction. Note that an interaction is a concept including an expression of intentions (questions, answers, and the like) exchanged between generation server 400 and the user.

Herein, patent classifications have been described as an example of format information including necessary description items for a job history document. Patent classifications are not limited to IPCs, but F terms, FI terms, Cooperative Patent Classification (CPC), and the like may be adopted.

### Other Modifications

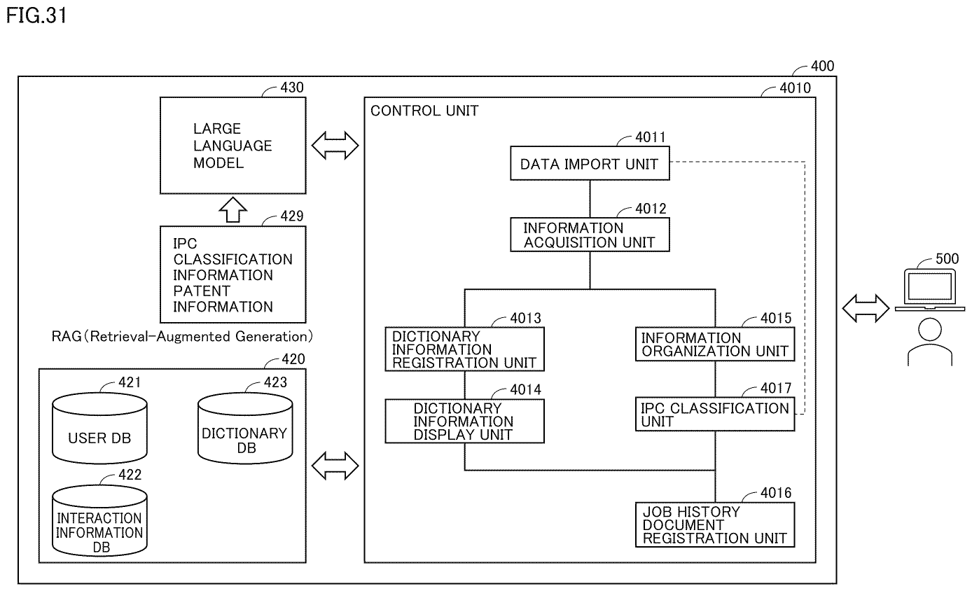

FIG. 31 is a diagram showing an example in which the Retrieval-Augmented Generation (RAG) technology is utilized for the functional configuration of generation server 400. RAG is a technology for configuring a large language model so as to access a knowledge source including latest accurate information, to cause the large language model to generate an answer based on the knowledge source. As is well known, a large language model may sometimes output inaccurate or misleading information, which is referred to as a hallucination. RAG can complement such an imperfect operation of the large language model and improve the quality of the answer generated by the large language model.

In order to improve the accuracy in selecting an IPC, generation server 400 may be provided with an IPC database 429 in which IPCs, patent information, and the like are stored, as shown in FIG. 31. Large language model 430 acquires IPCs from IPC database 429 and specifies candidates for IPCs considered to correspond to the user's skill based on the acquired IPCs.

Thereby, large language model 430 can be prevented from outputting an answer corresponding to a hallucination. As a result, large language model 430 can be improved in accuracy and reliability. Further, a system administrator can easily access the information source from which large language model 430 has derived an answer. Thereby, the system administrator can easily determine the accuracy of the answer obtained from large language model 430.

In general, adopting the RAG technology makes it possible to create an interaction AI that is specialized for a desired function and that can obtain a desired answer more precisely. For example, incorporating in-house confidential information also makes it possible to create an interaction AI that is assumed to be operated exclusively inside a company. Further, a large pieces of information according to a purpose can also be input to large language model 430. Further, there is also an advantage that the types of large language model 430 can be easily switched.

In general, in order to obtain an appropriate answer from a generative AI, it is important to enhance the quality of a prompt that is input by the user when the user interacts with the generative AI. As a technique for enhancing the quality of such a prompt, prompt engineering is known. Prompt engineering is a technology for developing and optimizing a prompt given to a large language model in order to efficiently use the large language model. Prompt engineering is a method of optimizing an output to a specific task on the assumption that an existing model is utilized.

In contrast, there is a concept of fine tuning. Fine tuning is a method of improving the performance for a specific task by causing an existing model to conduct additionally learning. In fine tuning, at least a part of the learned model generated based on one data set is additionally learned based on another data set. Thereby, the parameters of the machine learning model are finely tuned for a specific task. Fine tuning may be broadly interpreted as one of transfer learning. However, fine tuning is different from transfer learning in that fine tuning is a method of finely tuning the weights of all layers of the learned model, whereas transfer learning is a method of fixing the weights of the learned models and conducting learning using only added layers.

There is a problem in fine tuning that enormous computational resources are necessary since a large language model having a large number of parameters is required to conduct additional learning. Prompt tuning solves this problem by an approach different from that of fine tuning. In prompt tuning, the prompt itself is a learning target. In other words, in prompt tuning, parameters corresponding to prompts are assumed to be targets to be optimized.

Reinforcement learning from human feedback (RLHF) is a learning method of a model that is obtained by combining “supervised learning”, “reinforcement learning”, and “inverse reinforcement learning”. RLHF allows AI to learn a difficult and complicated task like natural language processing while minimizing elements requiring human involvement like supervised learning. Thus, learning of large language model 430 may be conducted by such RLHF.

In the present embodiment, a large language model is cited as an example of a natural language processing algorithm. However, the algorithm that can be adopted as a natural language processing algorithm is not limited to a large language model. For example, an algorithm generated by a rule-based method such as pattern matching may be adopted in place of a large language model.

User device 500 (recruiter device 200 and applicant device 300) may not only include all of the processor, the memory, the communication interface, and the input/output interface shown in FIG. 2, but also may be a thin client system or the like using a Virtual Desktop Infrastructure (VDI). The thin client system using VDI is a system in which a desktop environment on a server is transferred to a terminal at a remote location and used therein. User device 500 (recruiter device 200 and applicant device 300), sharing server 100, and generation server 400 do not necessarily have to be independent devices. When the thin client system as described above is used, the functions of user device 500, sharing server 100, and generation server 400 can be provided on the same aggregation server.

Databases 120 and 420 are not limited to relational databases, but may be object-type databases, NoSQL-type databases, or the like.

Each of sharing server 100 and generation server 400 is an example of a compute device. The compute device may be configured by a server (an on-premise server, a cloud server, or the like), a serverless system, or the like. In this case, the on-premise server is a server that is installed in a facility managed in its own company and is managed therein. The cloud server is a server (a borrowed server) provided by another service provider through a network. The serverless system is a system capable of using a compute memory function only when necessary, without being aware of the presence of the server. The compute device includes a server and a serverless system. Servers include an on-premises server and a cloud server.

### Aspects

Aspects of the present disclosure will be listed below.

(Clause 1) A job history information collection apparatus (generation servers 400, 400A) according to Clause 1 includes: an acquisition unit that acquires format information including a necessary description item for a job history document (step S11); a collection unit that collects job history information related to a job history of a user (steps S11, S22); and a storage unit (storage 403) that stores a natural language processing algorithm, wherein the collection unit collects the job history information corresponding to the necessary description item by an interaction with the user through use of the natural language processing algorithm stored in the storage unit (step S22).

(Clause 2) The job history information collection apparatus according to Clause 2, in addition to the job history information collection apparatus according to Clause 1, further comprising a creation unit that creates the job history document through use of the job history information collected by the collection unit (step S53), wherein, when the collection unit completes collection of the job history information related to the necessary description item, the creation unit creates the job history document according to the format information through use of the natural language processing algorithm stored in the storage unit (step S53).

(Clause 3) The job history information collection apparatus according to Clause 3, in addition to the job history information collection apparatus according to Clause 2, further comprising a job history database (user database 421) in which job history information collected before the interaction by the collection unit is registered, wherein, when the job history information registered in the job history database includes information corresponding to the necessary description item, the creation unit creates the job history document based on the job history information registered in the job history database (step S13).

(Clause 4) The job history information collection apparatus according to Clause 4, in addition to the job history information collection apparatus according to Clause 2 or 3, further comprising an output unit configured to output the job history document created by the creation unit to a user device (steps S110, S115: generation server 400 may have a function of sharing server 100), wherein, in a matching system that provides matching between a recruiter who recruits an order receiver of a business and an applicant, the user device is a recruiter device (200) that is operated by the recruiter or an applicant device (300) that is operated by the applicant.

(Clause 5) The job history information collection apparatus according to Clause 5, in addition to the job history information collection apparatus according to any one of Clauses 1 to 4, further comprising: a dictionary database (dictionary database 423); a registration unit that registers, in the dictionary database, a meaning of a term included in the job history information (step S34); and a display unit that causes a display device (user device 500) to display the job history document (step S43), wherein, when the term registered in the dictionary database is included in the job history document, the display unit causes the display device to display the meaning of the term (step S44).

(Clause 6) The job history information collection apparatus according to Clause 6, in addition to the job history information collection apparatus according to Clause 5, wherein the collection unit inquires of the user about the meaning of the term while interacting with the user (step S32).

(Clause 7) The job history information collection apparatus according to Clause 7, in addition to the job history information collection apparatus according to any one of Clauses 1 to 6, wherein the natural language processing algorithm includes a large language model (large language models 430, 430A, 430B).

(Clause 8) The job history information collection apparatus according to Clause 8, in addition to the job history information collection apparatus according to any one of Clauses 1 to 7, wherein the collection unit collects patent classification information related to a job of the user based on information acquired from the user through the interaction (step S75), and the job history information includes the patent classification information.

(Clause 9) The job history information collection apparatus according to Clause 9, in addition to the job history information collection apparatus according to Clause 8, wherein the collection unit presents, to the user, a plurality of pieces of the patent classification information related to the job of the user based on the information acquired from the user through the interaction, and subsequently fixes the patent classification information corresponding to selection by the user as the job history information (steps S72 to S75).

(Clause 10) A method according to Clause 10 is a method of creating a collection of job history information, the method causing a computer to perform: acquiring format information including a necessary description item for a job history document; and collecting job history information related to a job history of a user, wherein the collecting includes collecting the job history information corresponding to the necessary description item by an interaction with the user through use of a natural language processing algorithm.

It should be understood that the embodiments disclosed herein are illustrative and non-restrictive in every respect. The scope of the present invention is defined by the terms of the claims, rather than the description of the above embodiments, and is intended to include any modifications within the scope and meaning equivalent to the terms of the claims.

### Reference Signs List

1 matching system, 50 Internet, 100 sharing server, 101 processor, 102 memory, 103 storage, 104 communication interface, 120 database (DB), 121 company database (company DB), 122 member database (member DB), 123 community database (community DB), 124 recruitment case database (recruitment case DB), 200, 200A, 200B, 200C recruiter device, 201 processor, 202 memory, 203 communication interface, 204 input/output interface, 205 display, 206 operation unit, 300, 300A, 300B, 300C applicant device, 301 processor, 302 memory, 303 communication interface, 304 input/output interface, 305 display, 306 operation unit, 400, 400A generation server, 401 processor, 402 memory, 403 storage, 404 communication interface, 410 program, 411 interaction program, 412 checking program, 413 creation program, 420 database (DB), 421 user database (user DB), 422 interaction information database (interaction information DB), 423 dictionary database (dictionary DB), 426 sufficiency requirement database (sufficiency requirement DB), 427 original information storage database (original information storage DB), 428 generation format database (generation format DB), 429 IPC database, 430, 430A, 430B large language model, 500, 500A user device, 550 screen, 551 question frame, 552 answer frame, 601 to 603 button, 4010, 4010A control unit, 4011 data import unit, 4012 information acquisition unit, 4013 dictionary information registration unit, 4014 dictionary information display unit, 4015 information organization unit, 4016 job history document registration unit, 4017 IPC classification unit, 4021 input unit, 4022 content sufficiency determination unit, 4023 input request unit, 4024 original information storage unit, 4025 generation unit, 4026 check request unit, 4027 output unit, 4110 interaction AI, 4120 checking AI, 4130 creation AI.

1. A job history information collection apparatus comprising:
a memory configured to store computer code of a natural language processing algorithm; and
circuitry configured to
acquire format information including a necessary description item for a job history document,
collect job history information related to a job history of a user by an interaction with the user and the natural language processing algorithm,
determine whether the collected job history information satisfies a sufficiency requirement for the necessary description item using the natural language processing algorithm, and
in response to a determination by the circuitry that the sufficiency requirement is satisfied, generate the job history document according to the format information.

2. The job history information collection apparatus according to claim 1, further comprising:
a database configured to store job history information collected before the interaction,
wherein, when the job history information stored in the database includes information corresponding to the necessary description item, the circuitry is configured to generate the job history document based on the job history information stored in the database.

3. The job history information collection apparatus according to claim 1, further comprising:
a communication interface configured to output the job history document generated by the circuitry to a user device,
wherein the user device is a recruiter device operated by a recruiter or an applicant device operated by the applicant in a matching system that provides matching between the recruiter who recruits an order receiver of a business and the applicant.

4. The job history information collection apparatus according to claim 1, further comprising:
a data storage that stores a dictionary database; and
a display, wherein
the circuitry is configured to register, in the dictionary database, a meaning of a term included in the collected job history information, and
when the term registered in the dictionary database is included in the generated job history document, the circuitry causes the display to display the meaning of the term.

5. The job history information collection apparatus according to claim 4, wherein
the circuitry is configured to inquire of the user about the meaning of the term during an interaction session with the user.

6. The job history information collection apparatus according to claim 1, wherein
the natural language processing algorithm includes a large language model.

7. The job history information collection apparatus according to claim 1, wherein
the circuitry is configured to collect patent classification information related to a job of the user based on information acquired from the user through the interaction, and
the collected job history information includes the patent classification information.

8. The job history information collection apparatus according to claim 7, wherein
the circuitry is configured to present, to the user, a plurality of pieces of the patent classification information related to the job of the user based on the information acquired from the user through the interaction, and subsequently fix the patent classification information corresponding to a selection by the user as the job history information.

9. The job history information collection apparatus according to claim 1, wherein
the necessary description item includes items corresponding to a situation, a task, an action, and a result of the job history of the user, and
the circuitry is configured to cause the interaction to diverge to collect the job history information corresponding to the situation, the task, the action, and the result.

10. The job history information collection apparatus according to claim 9, wherein
the circuitry is configured to, in a divergence phase, repeat the interaction until the collected job history information corresponding to the necessary description item satisfies the sufficiency requirement, and
in a convergence phase after the divergence phase, generate the job history document.

11. A job history information collection apparatus comprising:
a memory configured to store a sufficiency requirement for a job history document; and
circuitry configured to
acquire job history information from a user through an interaction with the user using a large language model,
determine whether the acquired job history information satisfies the sufficiency requirement stored in the memory,
in a case where the acquired job history information does not satisfy the sufficiency requirement, control execution of an additional interaction with the user to acquire additional information, and
in a case where the acquired job history information satisfies the sufficiency requirement, generate the job history document based on the acquired job history information.

12. The job history information collection apparatus according to claim 11, wherein
the circuitry is configured to determine whether the acquired job history information satisfies the sufficiency requirement by determining whether a number of characters in the acquired job history information reaches a prescribed number, or whether a specific keyword is included in the acquired job history information.

13. The job history information collection apparatus according to claim 11, wherein
the circuitry is configured to, in the additional interaction, present options for a reason of a specific event included in the job history information to the user, and acquire the additional information based on a selection of the options by the user.

14. The job history information collection apparatus according to claim 11, wherein
the circuitry is configured to operate in a divergence phase and a convergence phase,
in the divergence phase, the circuitry repeats the interaction and the additional interaction until the job history information satisfying the sufficiency requirement is acquired, and
in the convergence phase, the circuitry generates the job history document.

15. The job history information collection apparatus according to claim 11, further comprising:
a knowledge source database storing accurate information,
wherein the large language model is configured to access the knowledge source database to generate an answer in the interaction using Retrieval-Augmented Generation (RAG).

16. The job history information collection apparatus according to claim 11, wherein
the circuitry is configured to present a plurality of patent classifications corresponding to the job history information to the user, and
the circuitry generates the job history document including a patent classification selected by the user from among the plurality of patent classifications.

17. The job history information collection apparatus according to claim 16, wherein
the patent classifications include an International Patent Classification (IPC).

18. The job history information collection apparatus according to claim 11, wherein
the circuitry is configured to generate a link associating a term in the generated job history document with a meaning of the term registered in a dictionary database.

19. The job history information collection apparatus according to claim 11, wherein
the circuitry is configured to receive draft data of the job history document from the user, and
determine whether the draft data satisfies the sufficiency requirement.

20. A method of collecting job history information, the method comprising:
acquiring format information including a necessary description item for a job history document;
collecting job history information related to a job history of a user by an interaction with the user using a natural language processing algorithm;
determining whether the collected job history information satisfies a sufficiency requirement for the necessary description item using the natural language processing algorithm; and
in response to determining that the sufficiency requirement is satisfied, generating the job history document according to the format information.
